(19) United States
(12) Patent Application Publication
(10) Pub. No.: US 2025/0284761 A1
(43) Pub. Date: Sep. 11, 2025

(54) APPARATUS AND A METHOD FOR THE IDENTIFICATION OF DYNAMIC SUB-TARGETS

(71) Applicant: The Strategic Coach Inc., Toronto (CA)

(72) Inventors: Barbara Sue Smith, Toronto (CA); Daniel J. Sullivan, Toronto (CA)

(73) Assignee: The Strategic Coach Inc., Toronto (CA)

(21) Appl. No.: 18/601,750

(22) Filed: Mar. 11, 2024

(51) Int. Cl. G06F 17/11

(52) U.S. Cl. CPC G06F 17/11; G06Q 10/06375; G06Q 10/0639

(57) ABSTRACT

An apparatus for the identification of dynamic sub-targets is disclosed. The apparatus includes a processor and a memory communicatively connected to the processor. The memory instructs the processor to receive a plurality of entity data comprising a plurality of product data. The processor identifies one or more static targets as a function of the plurality of entity data. The processor identifies a first set of dynamic sub-targets as a function of the one or more static targets and the plurality of product data. The memory instructs the processor to iteratively determine a static target status as a function of the first set of dynamic sub-targets and the one or more static targets. The processor identifies a second set of dynamic sub-targets as a function of the static target status. The processor generates a target report as a function of the static target status and the second set of dynamic sub-targets.

### FIELD OF THE INVENTION

The present invention generally relates to the field of dynamic target generation. In particular, the present invention is directed to an apparatus and a method for the identification of dynamic sub-targets.

### BACKGROUND

Optimizing an objective function related to goal-oriented processes has proven to be a labor intensive and time consuming process. This is due to the large number of variables that need to be evaluated to create and optimize the objective function. Efforts to continuously optimize objective functions with the constraints of static goals and real-time data and feedback have proven to be a long a challenging process. There is severe need for an inventive approach that ensures a more agile and responsive approach to this optimization problem.

### SUMMARY OF THE DISCLOSURE

In an aspect, an apparatus for the identification of dynamic sub-targets is disclosed. The memory instructs the processor to receive a plurality of entity data comprising a plurality of product data associated with an entity. The memory instructs the processor to identify one or more static targets as a function of the plurality of entity data using a first objective function. Identifying the one or more static targets includes receiving a target area from a user. Identifying the one or more static targets includes selecting a target metric as a function of the target area. Identifying the one or more static targets includes generating a first objective function as a function the target metric. Identifying the one or more static targets includes selecting the one or more static targets as a function of the optimization of the first objective function. The memory instructs the processor to identify a first set of dynamic sub-targets as a function of the one or more static targets and the plurality of product data. The memory instructs the processor to iteratively determine a static target status as a function of the first set of dynamic sub-targets and the one or more static targets. The memory instructs the processor to identify a second set of dynamic sub-targets as a function of the static target status and the plurality of product data. The memory instructs the processor to generate a target report as a function of the static target status and the second set of dynamic sub-targets.

In another aspect, a method for the identification of dynamic sub-targets is disclosed. The method includes receiving, using at least a processor, a plurality of entity data comprising a plurality of product data associated with an entity. The method includes identifying, using the at least a processor, one or more static targets as a function of the plurality of entity data using a first objective function. Identifying the one or more static targets includes receiving a target area from a user. Identifying the one or more static targets includes selecting a target metric as a function of the target area Identifying the one or more static targets includes generating a first objective function as a function the target metric. Identifying the one or more static targets includes selecting the one or more static targets as a function of the optimization of the first objective function. The method includes identifying, using the at least a processor, a first set of dynamic sub-targets as a function of the one or more static targets and the plurality of product data. The method includes iteratively determining, using the at least a processor, a static target status as a function of the first set of dynamic sub-targets and the one or more static targets. The method includes identifying, using the at least a processor, a second set of dynamic sub-targets as a function of the static target status and the plurality of product data. The method includes generating, using the at least a processor, a target report as a function of the static target status and the second set of dynamic sub-targets.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an exemplary embodiment of an apparatus for the identification of dynamic sub-targets;

FIG. 2 is a block diagram of an exemplary machine-learning process;

FIG. 3 is a block diagram of an exemplary embodiment of a target database;

FIG. 4 is a diagram of an exemplary embodiment of a neural network;

FIG. 5 is a diagram of an exemplary embodiment of a node of a neural network;

FIG. 6 is an illustration of an exemplary embodiment of fuzzy set comparison;

FIG. 7 is an illustration of an exemplary embodiment of a chatbot;

FIG. 8 is an illustration of an exemplary embodiment of user interface;

FIG. 9 is a flow diagram of an exemplary method for the identification of dynamic sub-targets; and FIG. 10 is a block diagram of a computing system that can be used to implement any one or more of the methodologies disclosed herein and any one or more portions thereof.

The drawings are not necessarily to scale and may be illustrated by phantom lines, diagrammatic representations, and fragmentary views. In certain instances, details that are not necessary for an understanding of the embodiments or that render other details difficult to perceive may have been omitted.

### DETAILED DESCRIPTION

At a high level, aspects of the present disclosure are directed to an apparatus and a method for the identification of dynamic sub-targets is disclosed. The memory instructs the processor to receive a plurality of entity data comprising a plurality of product data associated with an entity. The memory instructs the processor to identify one or more static targets as a function of the plurality of entity data using a first objective function. Identifying the one or more static targets includes receiving a target area from a user. Identifying the one or more static targets includes selecting a target metric as a function of the target area Identifying the one or more static targets includes generating a first objective function as a function the target metric. Identifying the one or more static targets includes selecting the one or more static targets as a function of the optimization of the first objective function. The memory instructs the processor to identify a first set of dynamic sub-targets as a function of the one or more static targets and the plurality of product data. The memory instructs the processor to iteratively determine a static target status as a function of the first set of dynamic sub-targets and the one or more static targets. The memory instructs the processor to identify a second set of dynamic sub-targets as a function of the static target status and the plurality of product data. The memory instructs the processor to generate a target report as a function of the static target status and the second set of dynamic sub-targets. Exemplary embodiments illustrating aspects of the present disclosure are described below in the context of several specific examples.

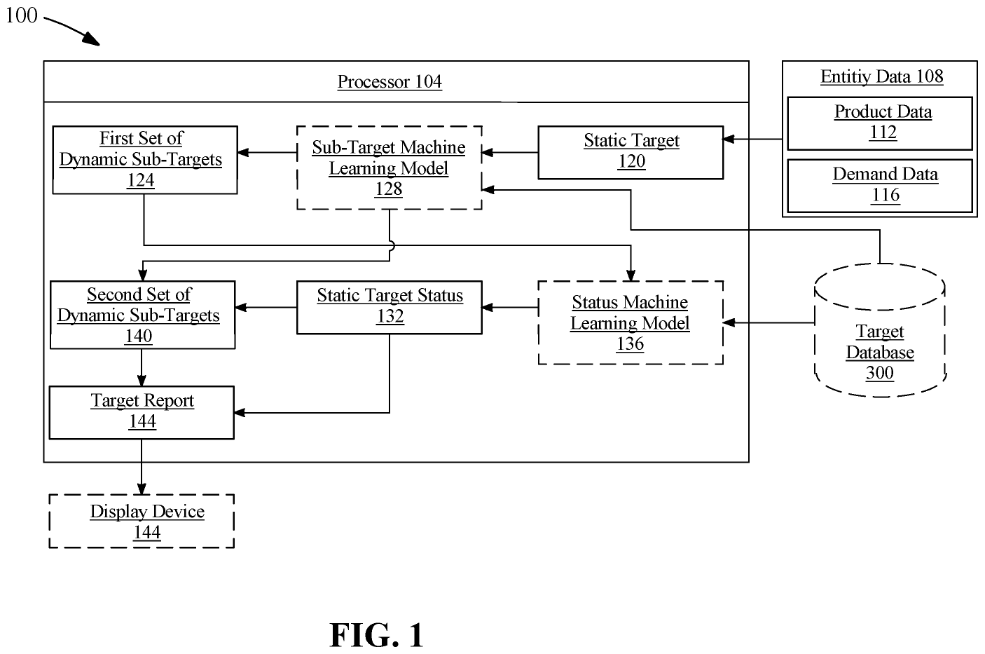

Referring now to FIG. 1, an exemplary embodiment of an apparatus 100 for the identification of dynamic sub-targets is illustrated. Apparatus 100 includes a processor 104. Processor 104 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Processor 104 may include a single computing device operating independently, or may include two or more computing device operating in concert, in parallel, sequentially or the like; two or more computing devices may be included together in a single computing device or in two or more computing devices. Processor 104 may interface or communicate with one or more additional devices as described below in further detail via a network interface device. Network interface device may be utilized for connecting processor 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus, or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Processor 104 may include but is not limited to, for example, a computing device or cluster of computing devices in a first location and a second computing device or cluster of computing devices in a second location. Processor 104 may include one or more computing devices dedicated to data storage, security, distribution of traffic for load balancing, and the like. Processor 104 may distribute one or more computing tasks as described below across a plurality of computing devices of computing device, which may operate in parallel, in series, redundantly, or in any other manner used for distribution of tasks or memory between computing devices. Processor 104 may be implemented using a “shared nothing” architecture in which data is cached at the worker, in an embodiment, this may enable scalability of apparatus 100 and/or computing device.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, apparatus 100 includes a memory. Memory is communicatively connected to processor 104. Memory may contain instructions configuring processor 104 to perform tasks disclosed in this disclosure. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, apparatus, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example, and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, without limitation, via a bus or other facility for intercommunication between elements of a computing device. Communicative connecting may also include indirect connections via, for example, and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, processor 104 may be configured to receive an entity data 108 from a user. For the purposes of this disclosure, “entity data” is data associated with an entity. As used in the current disclosure, an “entity” is an organization comprised of one or more persons with a specific purpose. An entity may include a corporation, organization, business, group, and the like. Entity data 108 may be created by a processor 104, a user, or a third party. The entity data 108 may include information regarding the entity's revenue, gross income, net income, business debts, a list of business expenses, current inventory, inventory history, sales information, human resource information, employee information, employee salaries, timecards, a list of company assets, a list of capital projects, accounting information, and the like. Entity data 108 may include information regarding the day-to-day activities of an entity. Entity data may include information about administrative tasks, operations and production, communications and collaborations, sales and marketing, financial management, customer service, human resources, information technology, research and development, and the like.

With continued reference to FIG. 1, entity data 108 may include product data 112. As used in the current disclosure, “product data” is data associated with the goods and services provided by the entity. Product data 112 may include a description of the goods and services that are provided by the entity. This may include information about the entity's products, including names, specifications, and features. Product data 112 may additionally include data associated with the cost to provide the goods and services. This may include the cost to the consumer and the cost to entity to provide the goods and services. Product data 112 may include information related to the inventory and/or capacity of the entity. This may include the current availability and stock levels of products. Alternatively, this may include capacity of the entity to provide services. Product data 112 may include a description of how the entity provides services to a consumer.

With continued reference to FIG. 1, Product data 112 may include information related to the sales performance of products. This may be important for evaluating the success and market acceptance of the goods offered by an entity. Product data 112 may include a quantity of units sold for each product/service. Product data 112 may include the total revenue generated by each product/service, calculated by multiplying the sales volume by the unit price. This may indicate the financial contribution of each product/service to the overall revenue. Product data 112 may include the price at which each unit of the product/service is sold. Product data may include a calculation of the profit margin for each product/service by subtracting the cost of goods sold (COGS) from the revenue generated. This helps assess the profitability of individual products. In some cases, product data 112 may include historical data on sales performance over time, showing trends, seasonality, and any patterns that may influence future sales forecasts. Product data 112 may include an identification of the channels through which products are sold (e.g., online, in-store, third-party retailers). This helps assess the performance of different distribution channels.

With continued reference to FIG. 1, processor 104 may iteratively generate updated product data as a function of the product data and a dynamic sub-target. As used in the current disclosure, “updated product data” is product data 112 that is continuously updated to provide up to date information regarding the products and services of the entity. This update can include updating product specifications, revising cost estimates, modifying inventory levels, and adapting descriptions of service delivery processes. The iterative updating of product data 112 by the processor 104 involves a dynamic process where information about the goods and services provided by an entity is continuously reviewed, revised, and enhanced. The processor 104 may iteratively collect new data related to the goods and services provided by the entity. This data can come from various sources such as sales transactions, customer feedback, supply chain information, and other relevant data streams. The processor 104 may compare the newly collected updated product data with historical product data 112 to identify trends, patterns, and changes over time. This analysis helps in understanding how product-related metrics have evolved. In some cases, processor 104 may employ automated analysis and machine learning algorithms, to identify insights from the updated product data. This may involve identifying changes in consumer preferences, detecting fluctuations in product demand, or recognizing cost variations. When generating updated product data 112 using machine learning algorithms, the processor 104 may leverage adaptive learning techniques. The system may learn from past iterations of the product data and refines the algorithms to better predict future changes in product-related metrics. Based on the analysis and insights gained, the processor 104 may dynamically update the product data. In some embodiments, the processor 104 may ensure that product data is updated in near real-time. This is particularly important for industries where rapid changes in market conditions or consumer behavior occur. The processor 104 may incorporate feedback mechanisms that allow users to provide input on the accuracy and relevance of the updated product data. This feedback loop helps in refining the updating process based on user insights. In certain contexts, the processor 104 may involve human validation and approval before finalizing updates to critical product data. This ensures a balance between automated processes and human oversight. In an additional embodiment, The processor may generate notifications or reports to inform stakeholders about the changes made to the product data. This helps keep relevant parties informed about updates and ensures transparency in the updating process. The processor may additionally update the entity data 108, target group, financial data, demand data 116, and the like in a manner similar to the manner in which the product data 112 was a updated.

With continued reference to FIG. 1, product data 112 may include financial data. As used in the current disclosure, “financial data” refers to the monetary aspects and data related to the products or services offered by an entity. Financial data may include information for managing the financial aspects of a business and understanding the economic impact of the products or services in question. Financial data may include information about the initial price of a product or service, any discounts or promotional pricing, and any additional charges such as taxes or shipping fees. Accurate pricing data is essential for revenue calculation. Financial information may include data on the revenue generated from the sale of products. This can be broken down by product, product category, and over specific time periods. Financial data may include information related to cost of goods sold (COGS) as represents the direct costs associated with the production or procurement of the products. It includes expenses like raw materials, labor, and manufacturing costs. Understanding COGS is crucial for calculating gross profit. Financial data may include information about profit margins.

Profit margins are calculated by subtracting the COGS from the revenue. This information helps assess the profitability of individual products and the business as a whole. Financial data may also include the valuation of the inventory, which is an asset on the balance sheet. Various methods like FIFO (First-In-First-Out) or LIFO (Last-In-First-Out) may be used to determine the value of inventory. If products are sold on credit, accounts receivable data is important. This represents the money owed to the business by customers who have yet to pay for their purchases. In addition to COGS, financial data may include information related to other operating expenses associated with selling the products, such as marketing, shipping, and overhead costs.

With continued reference to FIG. 1, entity data 108 may include a plurality of demand data 116. As used in the current disclosure, “demand data” is information regarding the market demand for the processes and procedures of the entity. Market demand may refer to total need within the market to accomplish a task or set of task using a process or procedure. It may represent the collective demand of all customers in the market for the goods and services. Additionally, demand data 116 may be calculated using sales data from the retailers and service providers who are present in the market. Demand data 116 may be calculated using several factors including the price range for goods and services, consumer preferences, target groups, target group budgets, consumer trends, market competition, market trends, and the like. Demand data 116 may include a description of the demand for goods and services within a geographic area. In an embodiment, demand data 116 may be described as a monetary value of the market. The monetary value of the market may be described as the sum of the value of the implementation of the processes or procedures across the market. This may include consulting costs, equipment costs, installation cost, employee training costs, and the like. These may be added up across the industry to provide the total monetary value of the market. Demand data 116 may include a prediction of the monetary value of the market at various time intervals. Determining the value of the market demand may involve assessing the market size, market growth, market growth rate, market growth potential, profit margins, and other relevant factors.

With continued reference to FIG. 1, Processor 104 may generate demand data 116 as a function of the market data. Processor 104 may collect relevant market data that provides insights into the demand drivers for the industry. Market data may include market research reports, industry surveys, government publications, trade associations' data, customer surveys, or any other reliable sources of information. This information may be gathered using a web crawler. In an embodiment, a web crawler may be configured to search a plurality of industry specific websites to gather market data. These websites may include government websites, accreditation body's websites, news websites, professional organizations websites, social media sites, and the like. The market data may additionally be generated by searching the websites of competitors within the industry. Market data may additionally be received from a database, wherein a database may include a plurality of industry specific market data. In some cases, processor 104 may use NLP models to identify market data from financial reports, stock markets forecasts, industry websites, governmental websites, and the like. Demand data 116 may include an analysis of economic indicators. This may include an analysis of macroeconomic indicators that can influence industry demand. Factors such as GDP growth, population trends, employment rates, inflation, consumer spending, and government policies can impact the overall demand for goods and services within an industry. In some embodiment, demand data 116 may include an analysis of the competitive landscape within a given industry. This may include an identification of the players within the market and their market share. This may include an identification and analysis of the market share and growth rates of key competitors, identify any emerging players or disruptive technologies, and consider the impact of industry-specific factors like barriers to entry, regulatory environment, and customer preferences.

With continued reference to FIG. 1, entity data 108 and/or product data 112 may be generated using tracking cookies. As used in the current disclosure, a “tracking cookie” is a small piece of data that a website sends to a user's web browser when they visit the site. These cookies are typically stored on the user's device, such as a computer or smartphone, and they serve various purposes, including tracking and collecting information about the user's online behavior. In some embodiments, tracking cookies may be used to generate the digital footprint of the consumer. The digital footprint of a consumer may then be used to generate entity data 108 and/or product data 112. Cookies may include small text files that websites and online services can place on a user's device to track their online activity. Cookies may work by sending a small amount of data from a website to a user's browser, which is then stored on the user's device. When the user visits the same website again, the browser sends the cookie data back to the website, allowing the website to remember the user's preferences and settings. There are two main types of cookies: session cookies and persistent cookies. Session cookies are temporary cookies that are deleted when the user closes their browser. Persistent cookies, on the other hand, remain on the user's device even after the browser is closed and can be used to remember the user's preferences for future visits to the website. While cookies can be useful for providing personalized experiences and improving website performance, they can also be used to track a user's digital footprint. By using cookies to track a user's online activity, processor 104 can build a detailed versions of entity data 108 and/or product data 112.

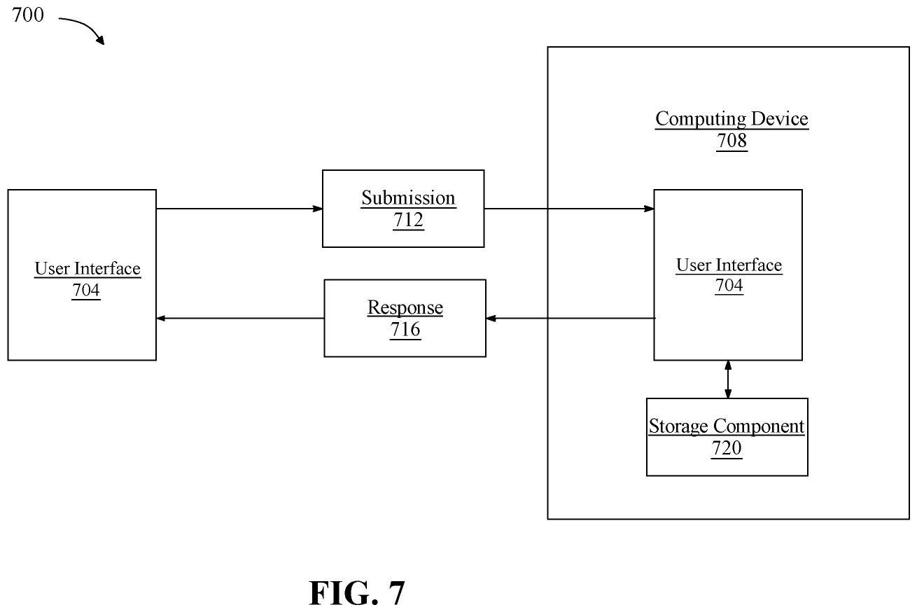

With continued reference to FIG. 1, entity data 108 and/or product data 112 may be received from a user and/or a consumer using a chatbot. A chatbot can be used to receive inputs from a user to generate entity data 108 and/or product data 112, wherein a chatbot input is discussed in greater detail herein below. The chatbot may be configured to ask a user a plurality of inquiries related to one or more aspects of their consumerism. The chatbot may use natural language processing techniques to understand and extract key information from the user's responses. This may help in determining the specific attributes or characteristics of the user's purchase history from the entity. Based on the collected data and user inputs, the chatbot may generate a structured entity data 108 and/or product data 112. Processor 104 may organize the information into different sections or categories based on the nature of the entity. This may be done using a chatbot as described herein below in FIG. 7.

With continued reference to FIG. 1, entity data 108 and/or product data 112 may be generated from one or more entity records. As used in the current disclosure, an “entity record” is a document that contains information regarding the entity. Entity records may include employee credentials, reports, financial records, medical records, business records, asset inventory, sales history, sales predictions, government records (i.e. birth certificates, social security cards, and the like), and the like. An entity record may additionally include operating records of the entity. Operating records may include things like data associated with the sales of goods and services by the entity. This may include things bills of sale, consumer records, sales projections, and the like. Entity records may be identified using a web crawler. Entity records may include a variety of types of “notes” entered over time by the entity, employees of the entity, support staff, advisors, consultants, tax professionals, financial professionals, and the like. Entity records may be converted into machine-encoded text using an optical character reader (OCR).

Still referring to FIG. 1, in some embodiments, optical character recognition or optical character reader (OCR) includes automatic conversion of images of written (e.g., typed, handwritten, or printed text) into machine-encoded text. In some cases, recognition of at least a keyword from an image component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes.

Still referring to FIG. 1, in some cases, OCR may be an “offline” process, which analyses a static document or image frame. In some cases, handwriting movement analysis can be used as input for handwriting recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

Still referring to FIG. 1, in some cases, OCR processes may employ pre-processing of image components. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to the image component to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from the background of the image component. In some cases, binarization may be required for example if an employed OCR algorithm only works on binary images. In some cases, a line removal process may include the removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify a script allowing an appropriate OCR algorithm to be selected. In some cases, a character isolation or “segmentation” process may separate signal characters, for example, character-based OCR algorithms. In some cases, a normalization process may normalize the aspect ratio and/or scale of the image component.

Still referring to FIG. 1, in some embodiments, an OCR process will include an OCR algorithm. Exemplary OCR algorithms include matrix-matching process and/or feature extraction processes. Matrix matching may involve comparing an image to a stored glyph on a pixel-by-pixel basis. In some cases, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at the same scale as input glyph. Matrix matching may work best with typewritten text.

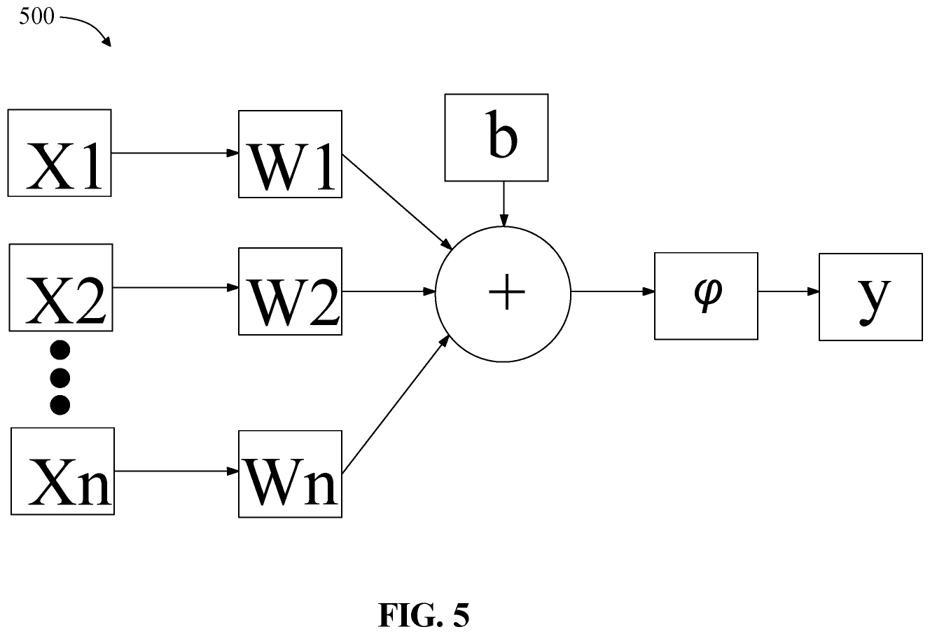

Still referring to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted features can be compared with an abstract vector-like representation of a character, which might reduce to one or more glyph prototypes. General techniques of feature detection in computer vision are applicable to this type of OCR. In some embodiments, machine-learning processes like nearest neighbor classifiers (e.g., k-nearest neighbors algorithm) can be used to compare image features with stored glyph features and choose a nearest match. OCR may employ any machine-learning process described in this disclosure, for example machine-learning processes described with reference to FIGS. 5-7. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

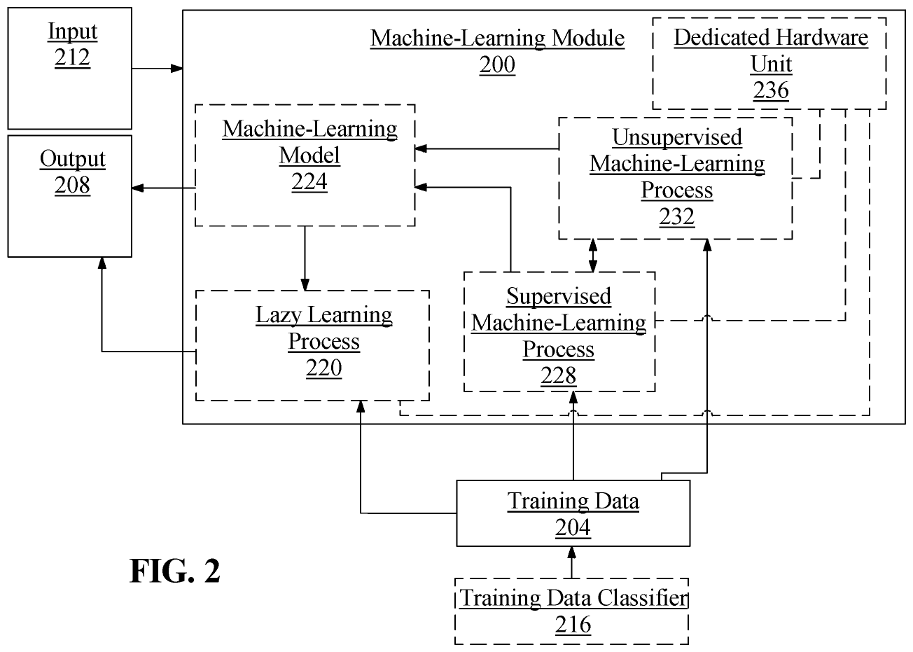

Still referring to FIG. 1, in some cases, OCR may employ a two-pass approach to character recognition. The second pass may include adaptive recognition and use letter shapes recognized with high confidence on a first pass to recognize better remaining letters on the second pass. In some cases, two-pass approach may be advantageous for unusual fonts or low-quality image components where visual verbal content may be distorted. Another exemplary OCR software tool include OCRopus. OCRopus development is led by German Research Centre for Artificial Intelligence in Kaiserslautern, Germany. In some cases, OCR software may employ neural networks, for example neural networks as taught in reference to FIGS. 2, 4, and 5.

Still referring to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make use of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

With continued reference to FIG. 1, entity data 108 and/or product data 112 may be generated using a web crawler. A “web crawler,” as used herein, is a program that systematically browses the internet for the purpose of web indexing. The web crawler may be seeded with platform URLs, wherein the crawler may then visit the next related URL, retrieve the content, index the content, and/or measure the relevance of the content to the topic of interest. In some embodiments, processor 104 may generate a web crawler to compile the entity data 108 and entity data. The web crawler may be seeded and/or trained with a reputable website, such as the user's business website, to begin the search. A web crawler may be generated by a processor 104. In some embodiments, the web crawler may be trained with information received from a user through a user interface. In some embodiments, the web crawler may be configured to generate a web query. A web query may include search criteria received from a user. For example, a user may submit a plurality of websites for the web crawler to search to extract entity records, inventory records, financial records, human resource records, past entity profiles 108, sales records, user notes, and observations, based on criteria such as a time, location, and the like. In some cases, a web crawler may be seeded with the website to the entities website. The process of seeding a web crawler refers to the process of providing an initial set of URLs or starting points from which the crawler begins its exploration of the web. These initial URLs are often called seed URLs or a seed set. Seeding may be a curtail step in the web crawling process as it defines the starting point for discovering and indexing web pages.

With continued reference to FIG. 1, processor 104 may identify a target group associated with the entity as a function of entity data 108. As used in the current disclosure, a “target group” is the client demographic that the entity targets. A target group may include data regarding the customers of the entity. A target group may identify the customers of the entity based on their characteristics (such as age, location, income, profession, or lifestyle). Customers may include entities and individuals alike. A target group may be identified for each product and/or service an entity offers. A target group may be identified as a function of a the demographics of the consumer. This may be done using historical versions of target groups for products and services that a similar to the current products or services that the entity is trying to promote. In an embodiment, historical versions of target groups may be stored in a database such as database 300. A target group may refer to a specific group of people that a product or service is designed for. The target group can be defined by various factors such as age, gender, income level, education, occupation, interests, lifestyle, industry, number of employees, and the like. A target group may be generated by evaluating the characteristics and behaviors of the specific previous clients as detailed in the entity data 108. In a non-limiting example, if an entity is launching a new line of beauty products, processor 104 may identify a target group as women between the ages of 18-35 who are interested in cosmetics and skincare.-Processor 104 may further refine this demographic by identifying additional factors such as income level, geographic location, social media presence, previous purchases, lifestyle, and the like.

With continued reference to FIG. 1, processor 104 is configured to identify one or more static targets 120 as a function of the plurality of entity data 108. As used in the current disclosure, a “static target” refers to an enduring and unwavering objective that maintains its specificity and definition without being influenced by time constraints or fluctuating circumstances. This type of target remains constant over an extended period, unaffected by short-term changes or external pressures. As used in the current disclosure, a “target” is a task or an accomplishment that the entity would like to achieve. Unlike dynamic goals that may evolve based on shifting priorities or circumstances, static targets 120 are characterized by their stability and persistence. The establishment static targets 120 may include targets that are specific, measurable, achievable, relevant, time-neutral, and the like. In a non-limiting example, a static target 120 may include achievement a specific market share, maintain a certain level of customer satisfaction, or establish a reputation for quality and innovation. These objectives serve as enduring benchmarks that guide decision-making and actions over an extended period, providing a consistent direction for the organization. The absence of a time limit distinguishes static targets 120 from time-bound objectives. They may not be subject to frequent adjustments or revisions, allowing for a clear and steady focus. While dynamic goals may be necessary to adapt to changing environments, static targets 120 may provide a foundational and unchanging framework, offering stability and continuity in the pursuit of a particular outcome. To identify the static targets 120 of the entity a processor may evaluate the business's internal strengths and weaknesses, as well as external opportunities and threats. This may be done by analyzing the entity data 108, product data 112, and the demand data 116. This may be done in an effort to identify areas where the business can capitalize on its strengths or mitigate weaknesses. Identifying the static targets 120 may additionally include analyzing the target group, discussed in greater detail herein below, to understand customer needs, preferences, and behaviors. The static targets 120 may include defined objectives that contribute to the long-term success of the business.

With continued reference to FIG. 1, processor 104 may generate static targets 120 as a function of a comparison of the entity data 108 of the current entity to the entity data of a similarly situated entity. Creating static targets 120 as a function of comparing entity data 108 may involve leveraging the information from the current entity and comparing it to a similarly situated second entity to establish specific and enduring objectives. Processor 104 may compare the entity data 108 by defining the specific data points or metrics within the entity data 108 that are crucial for evaluating the performance or characteristics of the entity. This could include financial data, demand data, product data, operational metrics, customer satisfaction scores, or other relevant key performance indicators (KPIs). In some cases, processor 104 may compare the characteristics of the current entity and the second entity at various points in time. For instance, if the second entity has experienced significant growth but at one time was similarly situated to the current entity processor 104 may compare the current entity to the historical version of the second entity. Processor 104 may additionally analyze the factors that lead to the second entity's growth when determining the static target 120 for the current entity. Processor 104 may identify a comparable second entity from a pool of entity data 108. Entity data 108 related to other entity may be stored within a database such as database 300. A comparable second entity may be an entity that operates in a similar industry, market, or business context. The goal may be to find an entity that shares similarities in terms of size, structure, target group, geographic location, and relevant business dynamics. Processor 104 may conduct a thorough comparison of the identified entity data 108 between the current entity and the selected entity. This may be done by comparing the similarities and differences to understand areas where the current entity may excel or lag behind in comparison to the selected entity. Processor 104 may identify areas where the selected second entity demonstrates exemplary performance or efficiency. Processor 104 may then extract the best practices and benchmarks from the selected second entity's entity data, which can serve as reference points for setting static targets 120 for the current entity. In some cases, processor may establish static targets 120 for the current entity by setting objectives that align with or surpass the performance the selected second entity in key areas. Processor 104 may ensure that newly established static targets 120 are specific, measurable, achievable, relevant, and time-neutral (SMART), providing a clear and constant direction for the current entity. Processor 104 may take into account industry standards and current trends to ensure that the static targets 120 are not only based on the comparison with the second entity but also align with broader industry expectations and advancements.

With continued reference to FIG. 1, processor 104 may be further configured to compare entity data 108 from the current entity and entity data from a second entity using a fuzzy matching process. As used in the current disclosure, a “fuzzy matching process” is a technique used in data analysis and information retrieval to compare and match strings or data points that are not an exact match but are similar or closely related. It is often used when dealing with data that may contain typos, abbreviations, variations in formatting, or minor differences. Processor 104 may first tokenize the keywords in each set of entity data. Tokenization involves breaking down the keyword sets into individual terms or tokens, which can be words or phrases. Processor 104 may be configured to choose a fuzzy matching algorithm or method based on specific requirements and the level of similarity you want to detect. Fuzzy matching algorithms may include Levenshtein distance, Jaccard Similarity, Cosine Similarity, Soundex and Metaphone, and the like. Processor 104 may be configured to determine a similarity threshold that defines what level of similarity is considered as a match. The threshold can be set based on the entity's requirements and the trade-off between precision and recall. A lower threshold will result in more lenient matches, while a higher threshold will require a stricter match. Processor 104 may apply the chosen fuzzy matching algorithm to compare the tokens in each set of entity data 108. Compute a similarity score for each pair of tokens. This score quantifies the degree of similarity between the tokens. Tokens with similarity scores above the defined threshold are considered as matched, wherein processor 104 may be configured to identify one or more static targets 120 as a function of the match.

With continued reference to FIG. 1, processor 104 may generate static targets 120 using a first objective function. As used in the current disclosure, a “first objective function” is mathematical formula that defines a measure of performance that needs to be either maximized or minimized for a static target 120. Determining static targets 120 using an objective function may involve defining a mathematical function that quantifies the goals or objectives that the entity desires to achieve. The objective function may serve as a measure of performance, and the process typically involves optimizing this function to reach specific targets. Processor 104 may generate an objective function representing the generation of static targets 120 by first identifying a target area in which the entity would like to set a static target 120. As used in the current disclosure, a “target area” is a specific domain or aspect of the entity's operations that the entity would like to establish a static target 120 in. Examples of target areas may include financial performance, operational efficiency, customer satisfaction, employee performance, revenue, profit margins, production efficiency, customer retention rates, and the like. A target area may be generated as a function of user input. In some cases, a processor 104 may present a user with a defined list of target areas for the user to select from. This list may be entity or industry specific. This may mean that the list may be tailored to the entity based on industry, revenue, product volume, number of employees, and the like. Once the target areas are identified the processor 104 may determine one or more target metrics associated with the target areas. As used in the current disclosure, a “target metric” is a metric or variable that represents the performance of the entity in relation to the target areas. A target metric may be a numerical measure that directly reflects or represents the performance of the entity. The processor 104 may use a lookup table to pair the target areas with a target metric. Examples of target metrics may include stat and/or metrics related to sales performance, manufacturing efficiency, customer satisfaction, employee performance, social media performance, revenue, and the like.

Still referring to FIG. 1, processor 104 may compute a score associated with each pairing of the target metric and an example of a static target 120 to minimize and/or maximize the score, depending on whether an optimal result is represented, respectively, by a minimal and/or maximal score. An objective function may be used by processor 104 to score each possible pairing. Objective function may be created based on one or more objectives as described below. In various embodiments a score of a particular parring of a target metric to a static target 120 may be based on a combination of one or more factors, including entity size, geographic location, revenue, costs, market trends, target area, customer service, and the like. Each factor may be assigned a score based on predetermined variables. In some embodiments, the assigned scores may be weighted or unweighted. Optimization of objective function may include performing a greedy algorithm process. A “greedy algorithm” is defined as an algorithm that selects locally optimal choices, which may or may not generate a globally optimal solution. For instance, processor 104 may select static targets 120 so that scores associated therewith are the best score for each combination of target metric and static target 120.

With continued reference to FIG. 1, optimizing objective function may include minimizing a loss function, where a “loss function” is an expression an output of which an optimization algorithm minimizes to generate an optimal result. As a non-limiting example, processor 104 may assign variables relating to a set of parameters, which may correspond to score components as described above, calculate an output of mathematical expression using the variables, and select static targets 120 that produces an output having the lowest size, according to a given definition of “size,” of the set of outputs representing each of plurality of candidate ingredient combinations; size may, for instance, included absolute value, numerical size, or the like. Selection of different loss functions may result in identification of different potential pairings as generating minimal outputs.

With continued reference to FIG. 1, a static target 120 of an entity may include a pecuniary target. As used in the current disclosure, a “pecuniary target” is a goal associated with the profitability of the entity. Static pecuniary targets may be specific, well-defined financial objectives that remain constant over time. These goals provide a stable and enduring direction for an individual, organization, or project without a time limit or frequent adjustments. Pecuniary targets may be associated with department of the entity or a specific good or service provided by the entity. Examples of pecuniary targets may include annual profit increases, cost efficiency, revenue diversification, cash flow stability, return on investment, debt management, profit margin improvement, financial reserves, investor value creation, and the like. In a non-limiting example, a pecuniary target may include maintaining a given profit margin for the entity as a whole or one or more specific goods/services. In another non-limiting example, a pecuniary target may include exploring and developing new revenue streams or expanding existing ones to diversify income sources and mitigate risks associated with dependence on a single revenue stream. Pecuniary targets may emphasize the importance of financial health and sustainability. By setting specific pecuniary targets and incorporating elements like cost efficiency, revenue diversification, and debt management, the goal aims to establish a robust financial foundation for the business. The static nature of this goal means that it serves as a constant guiding principle, promoting a focus on long-term financial growth and stability without being bound by specific timeframes.

With continued reference to FIG. 1, processor 104 may generate static target 120 using a target machine-learning model. As used in the current disclosure, a “target machine-learning model” is a machine-learning model that is configured to generate static target 120. target machine-learning model may be consistent with the machine-learning model described below in FIG. 2. Inputs to the target machine-learning model may include entity data 108, product data 112, demand data 116, financial data, entity data associated with a second entity, and the like. Outputs to the target machine-learning model may include static target 120 tailored to the entity data 108. A target machine learning model may be configured to generate static targets 120 for the current entity by comparing the entity data of the current entity to entity data of a second entity. The comparison is discussed in greater detail herein above. Additionally. A target machine learning model may be configured to generate a static target 120 by optimizing the first objective function. This may include selecting an objective function that maximizes the target metric of entity within the given constraints. This may include selecting a static target 120 that is in alignment with the target area.

Optimizing the objective function may include maximizing or minimizing the objective function depending on the identified target area. Target training data may include a plurality of data entries containing a plurality of inputs that are correlated to a plurality of outputs for training a processor by a machine-learning process. In an embodiment, target training data may include a plurality of entity data 108 correlated to examples of static target 120. Target training data may be received from database 300. Target training data may contain information about entity data 108, product data 112, demand data 116, financial data, entity data associated with a second entity, examples of static target 120, and the like. In an embodiment, target training data may be iteratively updated as a function of the input and output results of past target machine-learning model or any other machine-learning model mentioned throughout this disclosure. The machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model, and the like.

With continued reference to FIG. 1, processor 104 may identify a first set of dynamic sub-targets 124 as a function of the one or more static targets 120 and the plurality of product data 112. As used in the current disclosure, a “dynamic sub-target” are goals that are responsive to changing conditions. These sub-targets 124 may provide a more detailed and adaptable framework for achieving the overarching static targets 120. Unlike static targets 120, dynamic sub-targets 124 are flexible and subject to adjustment based on changing circumstances or evolving insights. These dynamic sub-targets 124 may serve as stepping stones or actionable targets that contribute to the achievement of overarching static targets 120. These may be specific, time-sensitive objectives that are created as a function of static targets 120 and product data 112. They are designed to be adaptable, allowing the entity to respond to changing market conditions or emerging opportunities. Dynamic sub-targets 124 may be adjusted based on the iterative analysis of product data 112. For instance, if certain products are underperforming, a dynamic sub-targets might involve implementing marketing strategies to boost their sales or introducing updates to enhance their features. While dynamic sub-targets 124 are adaptable, they may remain aligned with the broader static targets 120. They may serve as actionable steps that contribute to the overall achievement of the more enduring objectives set by the entity. In a non-limiting example, if a entity is assigned a static target 120 to maintain at least a 15% market share among the target group. A dynamic sub-target 124 derived from this may be related to the launch of a new product variant or the improvement of existing features to meet customer demands. A dynamic sub-target may include a first set of dynamic sub-targets 124, second set of dynamic sub-targets, a third set of dynamic sub-targets, up to a nth set of dynamic sub-targets.

With continued reference to FIG. 1, processor 104 may be configured to identify a target path for the entity. As used in the current disclosure, a “target path” is a series of one or more steps to progress the entity towards a target. This may include progression towards the static target 120 or the dynamic sub-targets. A target path may include a plurality of instructions regarding how to achieve a target. In an embodiment, a target path may be generated as a function of the identification of a dynamic sub-target. A target path may be a user goal 108 broken down into a series of sub-targets. In some embodiments, the sub-targets may be smaller or more simple goals used to progress the user towards user goal 108.

With continued reference to FIG. 1, processor 104 may generate dynamic sub-targets as a function of updated product data. Processor 104 may generate dynamic sub-targets by analyzing the recently updated product data, considering key metrics such as sales volume, revenue generation, customer segmentation, and any other relevant performance indicators. Based on the insights gained from the updated product data, the processor may identify a set a dynamic sub-target that is specific, measurable, achievable, relevant, and time bound. For example, the sub-target could be to increase the sales of a specific product by a certain percentage within the next quarter. Processor 104 may identify trends or patterns in the data. This may include the identification of products/services that are consistently performing well or those that might be experiencing a decline in sales. In some embodiments, this may include an assessment of the profit margins of each product, considering factors such as unit prices, production costs, and overall profitability. Processor 104 may identify products/services with high margins or areas where margins could be improved. The processor 104 may then generate the dynamic sub-targets based on the newly generated profit margins. For example, a new sub-target may be to reduce unit prices for a given product or service. In some cases, processor 104 may incorporate customer feedback and reviews into the analysis. This may be done to identify products/services that receive positive reviews and those that may have room for improvement based on customer suggestions. In another non-limiting example, processor 104 may generate sub-targets to improve areas where customers were dissatisfied. In other cases, processor 104 may consider the market share of each product, as a function of updated demand data. Processor 104 may identify sub-targets associated with opportunities to increase market share for specific products or areas where market dominance can be maintained. Processor 104 may evaluate inventory levels and stockouts as a function of updated product data. This may lead to the generation of sub-targets to promote the products with consistently high demand. This may additionally include sub-targets of increasing production of a product or making adjustments to current products based on changing demand. In an additional embodiment, processor 104 may Identify underperforming products and assess the reasons behind their lower sales using the updated product data. A sub-target may be generated associated with product improvements, marketing adjustments, or other strategies that could revitalize their performance.

Still referring to FIG. 1, processor 104 may compute a sub-target score associated with each pairing static target 120 and a dynamic sub target and select pairings to minimize and/or maximize the sub-target score, depending on whether an optimal result is represented, respectively, by a minimal and/or maximal score. As used in the current disclosure, a “second objective function” is mathematical formula that defines a measure of performance that needs to be either maximized or minimized for selection of a dynamic sub target. A second objective function may be used by processor 104 to score each possible pairing of a potential dynamic sub-target or sets of dynamic sub-targets to a static target 120. A second objective function may be based on one or more objectives as described below. In various embodiments a sub-target score of a particular pairing of dynamic sub-targets to static targets 120 may be based on a combination of one or more factors, including how well the completion of the dynamic sub-target will advance the entity towards the overarching goal of accomplishing the static target 120. Each factor may be assigned a score based on predetermined variables. In some embodiments, the assigned scores may be weighted or unweighted. Optimization of objective function may include performing a greedy algorithm process. A “greedy algorithm” is defined as an algorithm that selects locally optimal choices, which may or may not generate a globally optimal solution. For instance, processor 104 may select dynamic sub-targets so that sub-target scores associated therewith are the best score for each dynamic sub-targets. In an embodiment, the second objective function may be used to select the first set of dynamic sub target and/or the second set of dynamic sub targets.

Still referring to FIG. 1, objective function may be formulated as a linear objective function, which processor 104 may solve using a linear program such as without limitation a mixed-integer program. A “linear program,” as used in this disclosure, is a program that optimizes a linear objective function, given at least a constraint. For instance, the constraint may involve a static target 120 of keeping a manufacturing efficiency above 97%. In various embodiments, apparatus 100 may determine a dynamic sub-target related to a change of the manufacturing material maximizes a total score subject to a constraint related to the manufacturing efficiency.

With continued reference to FIG. 1, processor 104 may generate dynamic sub-targets using a sub-target machine-learning model 128. As used in the current disclosure, a “sub-target machine-learning model” is a machine-learning model that is configured to generate dynamic sub-targets. A sub-target machine-learning model 128 may be consistent with the machine-learning model described below in FIG. 2. Inputs to the sub-target machine-learning model 128 may include entity data 108, product data 112, updated product data, demand data 116, financial data, entity data associated with a second entity, static target 120, static target status 132, examples of dynamic sub-targets, and the like. Outputs to the sub-target machine-learning model 128 may include a first set dynamic sub-targets 124 tailored to the static targets 120 and product data 112. Additionally, outputs to the sub-target machine-learning model 128 may include a second set dynamic sub-targets 140 tailored to the static targets status 132 and product data 112. Additionally, sub-target machine learning model may be configured to generate a dynamic sub-targets by optimizing the second objective function. This may include selecting an objective function that maximizes the sub-target score within the given constraints provided by the static target 120. This may include selecting a dynamic sub-targets that is in alignment with the advancement of the static target 120. Optimizing the objective function may include maximizing or minimizing the objective function depending on the identified static target 120. Sub-target training data may include a plurality of data entries containing a plurality of inputs that are correlated to a plurality of outputs for training a processor by a machine-learning process. In an embodiment, sub-target training data may include a plurality of static targets 120 and product data 112 correlated to examples of a first set of dynamic sub-targets 124. In another embodiment, sub-target training data may include a plurality of static target status 132 and product data 112 correlated to examples of a second set of dynamic sub-targets 140. Sub-target training data may be received from database 300. Sub-target training data may contain information about entity data 108, product data 112, updated product data, demand data 116, financial data, entity data associated with a second entity, static target status 132, static target 120, examples of dynamic sub-targets, and the like. In an embodiment, sub-target training data may be iteratively updated as a function of the input and output results of past sub-target machine-learning model 128 or any other machine-learning model mentioned throughout this disclosure. The machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model, and the like.

With continued reference to FIG. 1, machine learning plays a crucial role in enhancing the function of software for generating a dynamic sub-targets. This may include identifying patterns of within the static targets 120 and product data 112 that lead to changes in the capabilities and type of the sub-target machine-learning model 128. By analyzing vast amounts of data related to the static targets 120 and product data 112, machine learning algorithms can identify patterns, correlations, and dependencies that contribute to a generating the sub-target machine-learning model 128. These algorithms can extract valuable insights from various sources, including evaluations of market share, profitability, and customer satisfaction associated with the entity. By applying machine learning techniques, the software can generate the sub-target machine-learning model 128 extremely accurately. Machine learning models may enable the software to learn from past iterations of sub-target machine-learning model 128 and iteratively improve its training data over time.

With continued reference to FIG. 1, processor 104 may be configured to update the training data of the sub-target machine-learning model 128 using user inputs. A sub-target machine-learning model 128 may use user input to update its training data, thereby improving its performance and accuracy. In embodiments, the sub-target machine-learning model 128 may be iteratively updated using input and output results of past iterations of the sub-target machine-learning model 128. The sub-target machine-learning model 128 may then be iteratively retrained using the updated sub-target training data. For instance, and without limitation, sub-target machine-learning model 128 may be trained using a first training data from, for example, and without limitation, a user input or database. The sub-target machine-learning model 128 may then be updated by using previous inputs and outputs from the sub-target machine-learning model 128 as second training data to then train a second machine learning model. This process of updating the sub-target machine-learning model 128 and its associated training data may be continuously done to create subsequent sub-target machine-learning models 128 to improve the speed and accuracy of the sub-target machine-learning model 128. When users interact with the software, their actions, preferences, and feedback provide valuable information that can be used to refine and enhance the model. This user input is collected and incorporated into the training data, allowing the machine learning model to learn from real-world interactions and adapt its predictions accordingly. By continually incorporating user input, the model becomes more responsive to user needs and preferences, capturing evolving trends and patterns. This iterative process of updating the training data with user input enables the machine learning model to deliver more customized and tailored results, ultimately enhancing the overall user experience. The discussion within this paragraph may apply to both the sub-target machine-learning model 128 or any other machine-learning model./classifier discussed herein.

Incorporating the user feedback may include updating the training data by removing or adding correlations of user data to a path or resources as indicated by the feedback. Any machine-learning model as described herein may have the training data updated based on such feedback or data gathered using a web crawler as described above. For example, correlations in training data may be based on outdated information wherein, a web crawler may update such correlations based on more recent resources and information.

With continued reference to FIG. 1, processor 104 may use user feedback to train the machine-learning models and/or classifiers described above. For example, machine-learning models and/or classifiers may be trained using past inputs and outputs of sub-target machine-learning model 128. In some embodiments, if user feedback indicates that an output of machine-learning models and/or classifiers was “bad,” then that output and the corresponding input may be removed from training data used to train machine-learning models and/or classifiers, and/or may be replaced with a value entered by, e.g., another value that represents an ideal output given the input the machine learning model originally received, permitting use in retraining, and adding to training data; in either case, classifier may be retrained with modified training data as described in further detail below. In some embodiments, training data of classifier may include user feedback.

With continued reference to FIG. 1, in some embodiments, an accuracy score may be calculated for the machine-learning model and/or classifier using user feedback. For the purposes of this disclosure, “accuracy score,” is a numerical value concerning the accuracy of a machine-learning model. For example, the accuracy/quality of the outputted sub-target machine-learning model 128 may be averaged to determine an accuracy score. In some embodiments, an accuracy score may be determined for pairing of entities. Accuracy score may indicate a degree of retraining needed for a machine-learning model and/or classifier. Processor 104 may perform a larger number of retraining cycles for a higher number (or lower number, depending on a numerical interpretation used), and/or may collect more training data for such retraining. The discussion within this paragraph and the paragraphs preceding this paragraph may apply to both the sub-target machine-learning model 128 or any other machine-learning model/classifier mentioned herein.

With continued reference to FIG. 1, processor 104 is configured to iteratively determine a static target status 132 as a function of the first set of dynamic sub-targets 124 and the one or more static targets 120. As used in the current disclosure, a “static target status” is data associated with the reflection of the overall progress and performance of an entity in achieving its long-term objectives. The processor 104 may regularly evaluate how well the dynamic sub-targets align with the overarching static targets 120. The dynamic sub-targets may be designed to contribute to the achievement of the broader, enduring objectives set by the entity. The static target status 132 may be an assessment whether the progress of dynamic sub-targets is in line with the strategic direction outlined in the static target 120. Additionally, the static target status 132 may be an assessment of how the achievement of each dynamic sub-target progresses an entity towards a static target 120. The processor 104 may regularly assess the progress of entity in achieving the dynamic sub-targets and the static targets 120. These dynamic sub-targets are specific, measurable, and time-bound objectives derived from the broader static targets. Monitoring their status may provide insights into the entity's short-to-medium-term performance and responsiveness to changing conditions. In an embodiment, processor 104 may establish vital metrics that reflect both dynamic sub-target achievements and progress toward static targets. Vital metrics may be quantifiable metrics used to measure and evaluate the success of an organization, department, project, or individual in achieving its objectives. vital metrics play a crucial role in providing insight into performance, facilitating data-driven decision-making, and enabling organizations to track progress toward their goals. These vital metrics serve as quantifiable measures of success and help in objectively assessing the entity's overall performance. In some embodiments, vital metrics may include key performance indicators (KPIs). The processor 104 may integrate performance metrics associated with dynamic sub-targets and static targets 120 into a comprehensive tracking system. This allows for a holistic view of the entity's progress and facilitates data-driven decision-making. The static target status 132 may incorporate feedback from the implementation of dynamic sub-targets. This may include an assessment of the effectiveness of strategies and initiatives undertaken to achieve these sub-targets. The processor 104 may use this feedback to make data driven adjustments to the sub-targets, ensuring that the entity remains on course to achieve both dynamic and static objectives.

With continued reference to FIG. 1, processor 104 may be configured to continuously update the static target status 132. The continuous updating of a static target status 132 may involve a systematic process of monitoring, analyzing, and reporting on the progress of an entity's long-term objectives. The processor may accomplish this by the iterative collection of relevant data associated with the static target 120 or dynamic sub-target 124. This may include information from various sources, including operational systems, databases, and external data streams. Additionally, this may include iteratively updated versions of the entity data 108, product data 112, demand data 116, financial data, target group, and the like. The collected data may be integrated into a centralized system, bringing together information from different sources to create a comprehensive dataset for analysis. In some embodiment, a static target status 132 may be updated in real time or near real time. Implementing real-time monitoring capabilities may allow the processor to track performance of the entity and other metrics as they are updated. This ensures that the status is continuously assessed, providing timely insights into performance. The processor may compare the current static target status 132 against predefined benchmarks and targets associated with the static targets 120. This comparison may identify whether the entity is on track to meet its long-term objectives. Utilizing machine learning algorithms and other analytical models, the processor may perform in-depth analysis of the data. This may involve trend analysis, anomaly detection, and other statistical methods to extract meaningful insights. In some embodiment, the processor may assesses the progress of the dynamic sub-targets and their contribution to the overall static targets 120. Adjustments to the dynamic sub-targets may be recommended based on this assessment. In an additional embodiment, The processor may be programmed to generate alerts or notifications when certain thresholds are reached or if deviations from the expected trajectory occur. This ensures that stakeholders are promptly informed of significant changes. Notifications may be sent to the user using email, text messages, push notifications, mail, and the like. In some cases, the processor may generate reports and visualizations to communicate the status of static targets 120. Dashboards may include charts, graphs, and other visual representations to facilitate easy comprehension of complex data. The processor may integrate a feedback loop mechanism that may allow the users to provide input on the analysis, interpretation, and recommendations. This iterative process helps refine the understanding of static target status. Based on the feedback loop, the processor may recommend adjustments or strategies for continuous improvement. These recommendations may involve refining processes, revising objectives, or adapting dynamic sub-target to address emerging challenges or opportunities.

With continued reference to FIG. 1, processor 104 may generate static target status 132 using a status machine-learning model 136. As used in the current disclosure, a “status machine-learning model” is a machine-learning model that is configured to generate static target status 132. Status machine-learning model 136 may be consistent with the machine-learning model described below in FIG. 2. Inputs to the status machine-learning model 136 may include entity data 108, product data 112, updated product data, demand data 116, financial data, entity data associated with a second entity, static target 120, a first set of dynamic sub-targets 124, examples of static target status 132, and the like. Outputs to the status machine-learning model 136 may include static target status 132 tailored to the first set of dynamic sub-targets 124 and the one or more static targets 120. Static training data may include a plurality of data entries containing a plurality of inputs that are correlated to a plurality of outputs for training a processor by a machine-learning process. In an embodiment, static training data may include a plurality of dynamic sub-targets 124 and the one or more static targets 120 correlated to examples of static target status 132. Static training data may be received from database 300. Static training data may contain information about entity data 108, product data 112, updated product data, demand data 116, financial data, entity data associated with a second entity, static target 120, a first set of dynamic sub-targets 124, examples of static target status 132, and the like. In an embodiment, static training data may be iteratively updated as a function of the input and output results of past status machine-learning model 136 or any other machine-learning model mentioned throughout this disclosure. The machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model, and the like.

With continued reference to FIG. 1, processor 104 may identify a second set of dynamic sub-targets 140 as a function of the static target status 132 and the plurality of product data 112. As used in the current disclosure, a “second set of dynamic sub-targets” are dynamic sub-targets that have been generated based changes to the static target status 132. A second set of dynamic sub-targets 140 may be created to improve upon the first set of sub-targets 124 and further advance the entity towards the static target 120. The processor 104 may additionally ensure that the second set of dynamic sub-targets 140 aligns with any adjustments made to the static target 120. This alignment ensures that the entity remains agile and responsive to changes in the operating environment. The processor 104 may identify a second set of dynamic sub-targets 140 by reviewing the status and outcomes of the first set of dynamic sub-targets 124 as denoted by the static target status 132. This may include an assessment of which goals were successfully achieved, which ones need improvement, and whether any adjustments were made during the process. The process may then evaluate the progress of the entity toward the static targets 120 in light of the first set of dynamic sub-targets 124. This may include an identification of areas where improvement is needed or where the initial sub-targets fell short of contributing effectively to the static targets. In some cases, the processor 104 may analyze the data to identify gaps in performance and areas where there are opportunities for enhancement. This may involve looking at various metrics, KPIs, and updated product data to understand where adjustments can lead to better alignment with the static targets 120. In some cases, the processor 104 may integrate feedback from users or the entity, including internal teams and external customers. The processor 104 may then compare the entity's performance against industry standards and competitors. This comparison may yield an identification of areas where the entity can outperform industry benchmarks or address weaknesses in comparison to industry leaders. The processor 104 may additionally be configured to account for external factors such as changes in market trends, economic conditions, and technological advancements. These external factors may influence the relevance and effectiveness of the initial sub-targets 120. In some cases, the processor 104 may establish a hierarchical structure for the second set of sub-targets 140, considering dependencies and relationships between different objectives. This ensures a cohesive and organized approach to implementation. In other cases, the processor 104 may conduct a risk assessment to identify potential challenges or obstacles associated with the second set of sub-targets 140. This may include the development mitigation strategies to address these risks proactively.

With continued reference to FIG. 1, processor 104 may select the a second set of dynamic sub-targets 140 as function of the second objective function. Processor 104 may incorporate the static target status 132 along with the static target 120 as constraints. In an embodiment, the second objective function may represent one or more aspects of the entity's performance, and the dynamic sub-targets serve as specific, adjustable goals within this function. The dynamic nature of these sub-targets suggests adaptability, allowing the system to respond to changing conditions or priorities. The selection process carried out by the processor reflects a nuanced approach to optimization, aligning the entity's objectives with the evolving landscape. To further refine the optimization procedure, the processor 104 may incorporate both the static target status 132 and the static target 120 as constraints. This dual constraint system introduces a layer of stability to the optimization process. The static target status 132 serves as a real-time indicator of progress or deviation from predefined goals, while the static target 120 establishes an overarching fixed goal that guides the optimization efforts. By incorporating these constraints, the processor 104 may ensures that the optimization aligns with not only the second set of dynamic sub-targets 140 derived from the second objective function but also the overarching static objectives, fostering a balance between adaptability and stability in the pursuit of optimal performance. The processor's role in selecting dynamic sub-targets based on the second objective function demonstrates a forward-looking and adaptable approach to optimization. Simultaneously, the incorporation of static targets 120 and their status as constraints provides a structured framework, ensuring that the optimization process remains anchored to overarching, stable objectives. This integrated approach reflects a comprehensive optimization methodology that considers both evolving dynamics and steadfast goals.

With continued reference to FIG. 1, processor 104 is configured to generate a target report 144 as a function of an updated static target status 132. As used in the current disclosure, a “target report” is a document that provides insights into an entity's progress toward its long-term objectives. This report is based on the latest information about an entity's progress towards the static targets 120, incorporating data, analysis, and contextual information. The report may provide a detailed overview of the static targets 120, including their definition, importance, and relevance to the entity's long-term vision. Each static target 120 may be clearly defined, and any changes or updates to the goals are highlighted. The target report 144 may present the most up-to-date information on the status of each static target 120. It may include quantitative and qualitative data, key performance indicators (KPIs), and other metrics relevant to each goal. The status is compared against benchmarks and targets. The target report 144 may include a comprehensive analysis of the achievements related to each static target 120 is provided. This includes a discussion of milestones reached, successful initiatives, and positive trends contributing to the overall progress. The target report 144 may additionally include any challenges, obstacles, or setbacks that have impacted the progress toward static targets are identified and discussed. This section may include an analysis of the root causes and potential strategies for overcoming these challenges. In an embodiment, a target report 144 may include a comparative analysis to assess the progression towards in the static targets 120 over previous reporting periods. This helps the entity/user understand the trajectory of progress and identify areas of improvement or concern. The report may discuss how these sub-targets contributed to the current static target status 120. The report may highlight specific achievements and adjustments made based on the outcomes of the dynamic sub-targets. If there were strategic adjustments made to the dynamic sub-targets, such as refinements or updates, these may be clearly communicated. The rationale behind these adjustments and their expected impact on future progress are discussed. In some cases, visual elements such as charts, graphs, and visualizations may be incorporated to provide a clear representation of the data. These visuals help stakeholders quickly grasp trends, patterns, and achievements.

With continued reference to FIG. 1, a target report 144 may include predictions about an entity's future cash flow. A target report 144 may include an analysis of the entity's current financial status, including its revenue streams, expenses, and existing capital. The target report 144 may include detailed tracking of the entity's current cash flow as it relates to its static targets 120. In an embodiment, the processor 104 may use the financial track record of the entity to predict future cash flows of the business. Processor 104 may employ financial models and market analysis to forecast future cash flows. These projections may be based on a variety of factors such as market trends, historical financial performance, upcoming projects, and potential investments. The target report 144 may also include an assessment of the risks and uncertainties that could impact future cash flows, offering scenarios under different market conditions. In some cases, processor 104 may provide strategic recommendations to optimize cash flow, such as cost reduction strategies, investment opportunities, or revenue enhancement initiatives.

With continued reference to FIG. 1, processor 104 may generate target report 144 using a report machine-learning model. As used in the current disclosure, a “report machine-learning model” is a machine-learning model that is configured to generate target report 144. report machine-learning model may be consistent with the machine-learning model described below in FIG. 2. Inputs to the report machine-learning model may include entity data 108, product data 112, updated product data, demand data 116, financial data, entity data associated with a second entity, static target 120, a first set of dynamic sub-targets 124, a second set of dynamic sub-targets 140, static target status 132, examples of target reports 144, and the like. Outputs to the report machine-learning model may include target report 144 tailored to the static target status 132. Report training data may include a plurality of data entries containing a plurality of inputs that are correlated to a plurality of outputs for training a processor by a machine-learning process. In an embodiment, report training data may include a plurality of static target status 132 correlated to examples of target report 144. Report training data may be received from database 300. report training data may contain information about entity data 108, product data 112, updated product data, demand data 116, financial data, entity data associated with a second entity, static target 120, a first set of dynamic sub-targets 124, a second set of dynamic sub-targets 140, static target status 132, examples of target report 144, and the like. In an embodiment, report training data may be iteratively updated as a function of the input and output results of past report machine-learning model or any other machine-learning model mentioned throughout this disclosure. The machine-learning model may be performed using, without limitation, linear machine-learning models such as without limitation logistic regression and/or naive Bayes machine-learning models, nearest neighbor machine-learning models such as k-nearest neighbors machine-learning models, support vector machines, least squares support vector machines, fisher's linear discriminant, quadratic machine-learning models, decision trees, boosted trees, random forest machine-learning model, and the like.

Still referring to FIG. 1, processor 104 may be configured to display the target report 144 using a display device 148. As used in the current disclosure, a “display device” is a device that is used to display a plurality of data and other digital content. Processor 104 may be configured to generate a display data structure, wherein the display data structure may be configured to cause a display device to display the target report or other data mentioned herein. A display device 148 may include a user interface. A “user interface,” as used herein, is a means by which a user and a computer system interact; for example through the use of input devices and software. A user interface may include a graphical user interface (GUI), command line interface (CLI), menu-driven user interface, touch user interface, voice user interface (VUI), form-based user interface, any combination thereof, and the like. A user interface may include a smartphone, smart tablet, desktop, or laptop operated by the user. In an embodiment, the user interface may include a graphical user interface. A “graphical user interface (GUI),” as used herein, is a graphical form of user interface that allows users to interact with electronic devices. In some embodiments, GUI may include icons, menus, other visual indicators, or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pulldown menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access. Information contained in user interface may be directly influenced using graphical control elements such as widgets. A “widget,” as used herein, is a user control element that allows a user to control and change the appearance of elements in the user interface. In this context a widget may refer to a generic GUI element such as a check box, button, or scroll bar to an instance of that element, or to a customized collection of such elements used for a specific function or application (such as a dialog box for users to customize their computer screen appearances). User interface controls may include software components that a user interacts with through direct manipulation to read or edit information displayed through user interface. Widgets may be used to display lists of related items, navigate the system using links, tabs, and manipulate data using check boxes, radio boxes, and the like.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm instantiated in hardware or software logic, data structures, and/or functions that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example one or more static targets and the plurality of product data as inputs and the dynamic sub-targets as outputs.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to an updated product data that shows changes in the quality, sales, profit-margin, and the like of a good/service provided by the entity.

With further reference to FIG. 2, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Still referring to FIG. 2, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may identified as having poor quality data, where “poor quality” is defined as having a signal to noise ratio below a threshold value.

As a non-limiting example, and with further reference to FIG. 2, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity, and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 2, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 2, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include one or more static targets 120 and the plurality of product data 112 as described above as inputs, a first/second dynamic sub-target as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With further reference to FIG. 2, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 2, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 232 may not require a response variable; unsupervised processes 232 may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 2, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 2, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 2, retraining and/or additional training may be performed using any process for training described above, using any currently or previously deployed version of a machine-learning model and/or algorithm as a starting point. Training data for retraining may be collected, preconditioned, sorted, classified, sanitized, or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 2, one or more processes or algorithms described above may be performed by at least a dedicated hardware unit 236. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 236 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 236 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 236 to perform one or more operations described herein, such as evaluation of model and/or algorithm outputs, one-time or iterative updates to parameters, coefficients, weights, and/or biases, and/or any other operations such as vector and/or matrix operations as described in this disclosure.

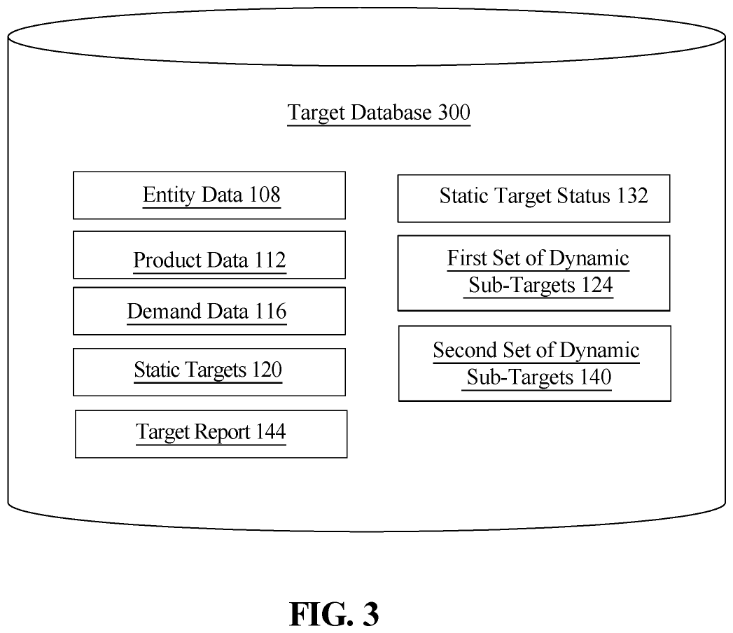

Now referring to FIG. 3, an exemplary target database 300 is illustrated by way of block diagram. In an embodiment, any past or present versions of any data disclosed herein may be stored within the target database 300 including but not limited to: entity data 108, product data 112, updated product data, demand data 116, financial data, entity data associated with a second entity, static target 120, a first set of dynamic sub-targets 124, a second set of dynamic sub-targets 140, static target status 132, target reports 144, and the like. Processor 104 may be communicatively connected with target database 300. For example, in some cases, database 300 may be local to processor 104. Alternatively or additionally, in some cases, database 300 may be remote to processor 104 and communicative with processor 104 by way of one or more networks. Network may include, but not limited to, a cloud network, a mesh network, or the like. By way of example, a “cloud-based” system, as that term is used herein, can refer to a system which includes software and/or data which is stored, managed, and/or processed on a network of remote servers hosted in the “cloud,” e.g., via the Internet, rather than on local severs or personal computers. A “mesh network” as used in this disclosure is a local network topology in which the infrastructure processor 104 connects directly, dynamically, and non-hierarchically to as many other computing devices as possible. A “network topology” as used in this disclosure is an arrangement of elements of a communication network. target database 300 may be implemented, without limitation, as a relational database, a key-value retrieval database such as a NOSQL database, or any other format or structure for use as a database that a person skilled in the art would recognize as suitable upon review of the entirety of this disclosure. target database 300 may alternatively or additionally be implemented using a distributed data storage protocol and/or data structure, such as a distributed hash table or the like. target database 300 may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

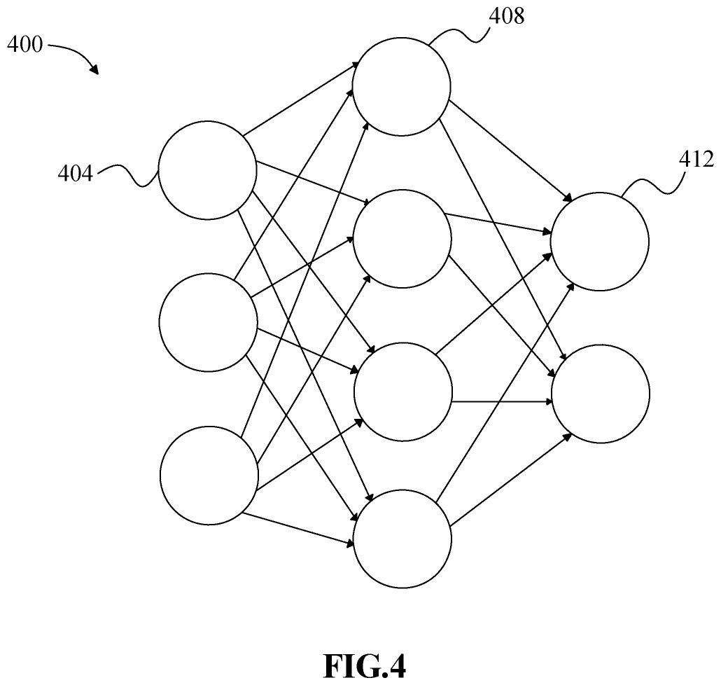

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

Referring now to FIG. 5, an exemplary embodiment of a node of a neural network is illustrated. A node may include, without limitation, a plurality of inputs xi that may receive numerical values from inputs to a neural network containing the node and/or from other nodes. Node may perform a weighted sum of inputs using weights wᵢ that are multiplied by respective inputs xi. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

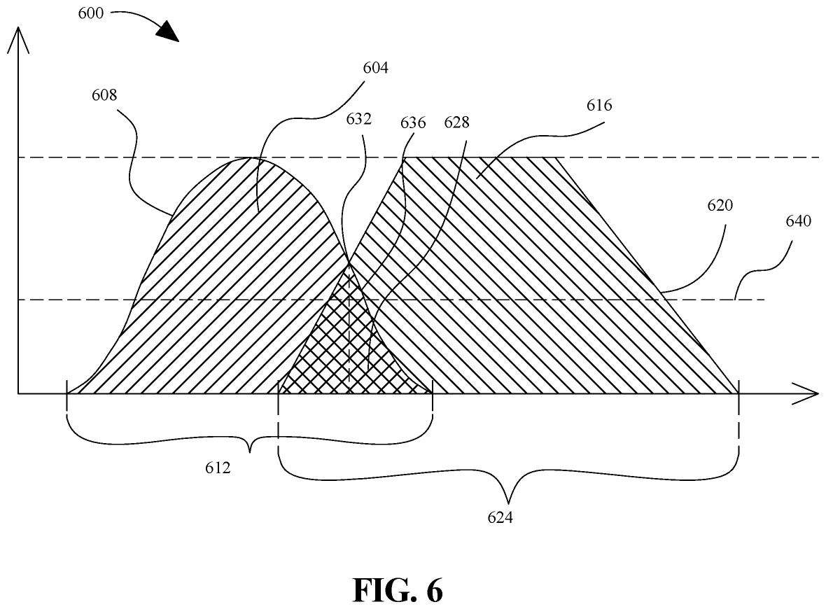

Now referring to FIG. 6, an exemplary embodiment of fuzzy set comparison 600 is illustrated. In a non-limiting embodiment, the fuzzy set comparison. In a non-limiting embodiment, fuzzy set comparison 600 may be consistent with fuzzy set comparison in FIG. 1. In another non-limiting the fuzzy set comparison 600 may be consistent with the name/version matching as described herein. For example and without limitation, the parameters, weights, and/or coefficients of the membership functions may be tuned using any machine-learning methods for the name/version matching as described herein. In another non-limiting embodiment, the fuzzy set may represent entity data 108 from the current entity and entity data from a second entity from FIG. 1.

Alternatively or additionally, and still referring to FIG. 6, fuzzy set comparison 600 may be generated as a function of determining the data compatibility threshold. The compatibility threshold may be determined by a computing device. In some embodiments, a computing device may use a logic comparison program, such as, but not limited to, a fuzzy logic model to determine the compatibility threshold and/or version authenticator. Each such compatibility threshold may be represented as a value for a posting variable representing the compatibility threshold, or in other words a fuzzy set as described above that corresponds to a degree of compatibility and/or allowability as calculated using any statistical, machine-learning, or other method that may occur to a person skilled in the art upon reviewing the entirety of this disclosure. In some embodiments, determining the compatibility threshold and/or version authenticator may include using a linear regression model. A linear regression model may include a machine learning model. A linear regression model may map statistics such as, but not limited to, frequency of the same range of version numbers, and the like, to the compatibility threshold and/or version authenticator. In some embodiments, determining the compatibility threshold of any posting may include using a classification model. A classification model may be configured to input collected data and cluster data to a centroid based on, but not limited to, frequency of appearance of the range of versioning numbers, linguistic indicators of compatibility and/or allowability, and the like. Centroids may include scores assigned to them such that the compatibility threshold may each be assigned a score. In some embodiments, a classification model may include a K-means clustering model. In some embodiments, a classification model may include a particle swarm optimization model. In some embodiments, determining a compatibility threshold may include using a fuzzy inference engine. A fuzzy inference engine may be configured to map one or more compatibility threshold using fuzzy logic. In some embodiments, a plurality of computing devices may be arranged by a logic comparison program into compatibility arrangements. A “compatibility arrangement” as used in this disclosure is any grouping of objects and/or data based on skill level and/or output score. Membership function coefficients and/or constants as described above may be tuned according to classification and/or clustering algorithms. For instance, and without limitation, a clustering algorithm may determine a Gaussian or other distribution of questions about a centroid corresponding to a given compatibility threshold and/or version authenticator, and an iterative or other method may be used to find a membership function, for any membership function type as described above, that minimizes an average error from the statistically determined distribution, such that, for instance, a triangular or Gaussian membership function about a centroid representing a center of the distribution that most closely matches the distribution. Error functions to be minimized, and/or methods of minimization, may be performed without limitation according to any error function and/or error function minimization process and/or method as described in this disclosure.

Still referring to FIG. 6, inference engine may be implemented according to input entity data 108 from the current entity and entity data from a second entity. For instance, an acceptance variable may represent a first measurable value pertaining to the classification of entity data 108 from the current entity to entity data from a second entity. Continuing the example, an output variable may represent static targets 120 associated with the user. In an embodiment, entity data 108 from the current entity and/or entity data from a second entity may be represented by their own fuzzy set. In other embodiments, the classification of the data into static targets 120 may be represented as a function of the intersection two fuzzy sets as shown in FIG. 6, An inference engine may combine rules, such as any semantic versioning, semantic language, version ranges, and the like thereof. The degree to which a given input function membership matches a given rule may be determined by a triangular norm or “T-norm” of the rule or output function with the input function, such as min (a, b), product of a and b, drastic product of a and b, Hamacher product of a and b, or the like, satisfying the rules of commutativity (T(a, b)=T(b, a)), monotonicity: (T(a, b)≤T(c, d) if a≤c and b≤d), (associativity: T(a, T(b, c))=T(T(a, b), c)), and the requirement that the number 1 acts as an identity element. Combinations of rules (“and” or “or” combination of rule membership determinations) may be performed using any T-conorm, as represented by an inverted T symbol or “1,” such as max (a, b), probabilistic sum of a and b (a+b−a*b), bounded sum, and/or drastic T-conorm; any T-conorm may be used that satisfies the properties of commutativity: ⊥(a, b)=⊥(b, a), monotonicity: ⊥(a, b)≤⊥(c, d) if a≤c and b≤d, associativity: ⊥(a, ⊥(b, c))=⊥(⊥(a, b), c), and identity element of 0. Alternatively or additionally T-conorm may be approximated by sum, as in a “product-sum” inference engine in which T-norm is product and T-conorm is sum. A final output score or other fuzzy inference output may be determined from an output membership function as described above using any suitable defuzzification process, including without limitation Mean of Max defuzzification, Centroid of Area/Center of Gravity defuzzification, Center Average defuzzification, Bisector of Area defuzzification, or the like. Alternatively or additionally, output rules may be replaced with functions according to the Takagi-Sugeno-King (TSK) fuzzy model.

A first fuzzy set 604 may be represented, without limitation, according to a first membership function 608 representing a probability that an input falling on a first range of values 612 is a member of the first fuzzy set 604, where the first membership function 608 has values on a range of probabilities such as without limitation the interval [0,1], and an area beneath the first membership function 608 may represent a set of values within first fuzzy set 604. Although first range of values 612 is illustrated for clarity in this exemplary depiction as a range on a single number line or axis, first range of values 612 may be defined on two or more dimensions, representing, for instance, a Cartesian product between a plurality of ranges, curves, axes, spaces, dimensions, or the like. First membership function 608 may include any suitable function mapping first range 612 to a probability interval, including without limitation a triangular function defined by two linear elements such as line segments or planes that intersect at or below the top of the probability interval. As a non-limiting example, triangular membership function may be defined as:

$$( x , a , b , c ) = \{ \begin{matrix}0 , for x > c and x < a \\ \frac{x - a}{b - a} , for a \leq x < b \\ \frac{c - x}{c - b} , if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

First fuzzy set 604 may represent any value or combination of values as described above, including any entity data 108 from the current entity and entity data from a second entity. A second fuzzy set 616, which may represent any value which may be represented by first fuzzy set 604, may be defined by a second membership function 620 on a second range 624; second range 624 may be identical and/or overlap with first range 612 and/or may be combined with first range via Cartesian product or the like to generate a mapping permitting evaluation overlap of first fuzzy set 604 and second fuzzy set 616. Where first fuzzy set 604 and second fuzzy set 616 have a region 636 that overlaps, first membership function 608 and second membership function 620 may intersect at a point 632 representing a probability, as defined on probability interval, of a match between first fuzzy set 604 and second fuzzy set 616. Alternatively or additionally, a single value of first and/or second fuzzy set may be located at a locus 636 on first range 612 and/or second range 624, where a probability of membership may be taken by evaluation of first membership function 608 and/or second membership function 620 at that range point. A probability at 628 and/or 632 may be compared to a threshold 640 to determine whether a positive match is indicated. Threshold 640 may, in a non-limiting example, represent a degree of match between first fuzzy set 604 and second fuzzy set 616, and/or single values therein with each other or with either set, which is sufficient for purposes of the matching process; for instance, the classification into one or more query categories may indicate a sufficient degree of overlap with fuzzy set representing entity data 108 from the current entity and entity data from a second entity for combination to occur as described above. Each threshold may be established by one or more user inputs. Alternatively or additionally, each threshold may be tuned by a machine-learning and/or statistical process, for instance and without limitation as described in further detail below.

In an embodiment, a degree of match between fuzzy sets may be used to rank one resource against another. For instance, if both entity data 108 from the current entity and entity data from a second entity have fuzzy sets, static targets 120 may be generated by having a degree of overlap exceeding a predictive threshold, processor 104 may further rank the two resources by ranking a resource having a higher degree of match more highly than a resource having a lower degree of match. Where multiple fuzzy matches are performed, degrees of match for each respective fuzzy set may be computed and aggregated through, for instance, addition, averaging, or the like, to determine an overall degree of match, which may be used to rank resources; selection between two or more matching resources may be performed by selection of a highest-ranking resource, and/or multiple notifications may be presented to a user in order of ranking.

Referring to FIG. 7, a chatbot system 700 is schematically illustrated. According to some embodiments, a user interface 704 may be communicative with a computing device 708 that is configured to operate a chatbot. In some cases, user interface 704 may be local to computing device 708. Alternatively or additionally, in some cases, user interface 704 may remote to computing device 708 and communicative with the computing device 708, by way of one or more networks, such as without limitation the internet. Alternatively or additionally, user interface 704 may communicate with user device 708 using telephonic devices and networks, such as without limitation fax machines, short message service (SMS), or multimedia message service (MMS). Commonly, user interface 704 communicates with computing device 708 using text-based communication, for example without limitation using a character encoding protocol, such as American Standard for Information Interchange (ASCII). Typically, a user interface 704 conversationally interfaces a chatbot, by way of at least a submission 712, from the user interface 708 to the chatbot, and a response 716, from the chatbot to the user interface 704. In many cases, one or both of submission 712 and response 716 are text-based communication. Alternatively or additionally, in some cases, one or both of submission 712 and response 716 are audio-based communication.

Continuing in reference to FIG. 7, a submission 712 once received by computing device 708 operating a chatbot, may be processed by a processor. In some embodiments, processor processes a submission 712 using one or more of keyword recognition, pattern matching, and natural language processing. In some embodiments, processor employs real-time learning with evolutionary algorithms. In some cases, processor may retrieve a pre-prepared response from at least a storage component 720, based upon submission 712. Alternatively or additionally, in some embodiments, processor communicates a response 716 without first receiving a submission 712, thereby initiating conversation. In some cases, processor communicates an inquiry to user interface 704; and the processor is configured to process an answer to the inquiry in a following submission 712 from the user interface 704. In some cases, an answer to an inquiry present within a submission 712 from a user device 704 may be used by computing device 708 as an input to another function.

With continued reference to FIG. 7, A chatbot may be configured to provide a user with a plurality of options as an input into the chatbot. Chatbot entries may include multiple choice, short answer response, true or false responses, and the like. A user may decide on what type of chatbot entries are appropriate. In some embodiments, the chatbot may be configured to allow the user to input a freeform response into the chatbot. The chatbot may then use a decision tree, data base, or other data structure to respond to the users entry into the chatbot as a function of a chatbot input. As used in the current disclosure, “Chatbot input” is any response that a candidate or employer inputs in to a chatbot as a response to a prompt or question.

With continuing reference to FIG. 7, computing device 708 may be configured to the respond to a chatbot input using a decision tree. A “decision tree,” as used in this disclosure, is a data structure that represents and combines one or more determinations or other computations based on and/or concerning data provided thereto, as well as earlier such determinations or calculations, as nodes of a tree data structure where inputs of some nodes are connected to outputs of others. Decision tree may have at least a root node, or node that receives data input to the decision tree, corresponding to at least a candidate input into a chatbot. Decision tree has at least a terminal node, which may alternatively or additionally be referred to herein as a “leaf node,” corresponding to at least an exit indication; in other words, decision and/or determinations produced by decision tree may be output at the at least a terminal node. Decision tree may include one or more internal nodes, defined as nodes connecting outputs of root nodes to inputs of terminal nodes. Computing device 708 may generate two or more decision trees, which may overlap; for instance, a root node of one tree may connect to and/or receive output from one or more terminal nodes of another tree, intermediate nodes of one tree may be shared with another tree, or the like.

Still referring to FIG. 7, computing device 708 may build decision tree by following relational identification; for example, relational indication may specify that a first rule module receives an input from at least a second rule module and generates an output to at least a third rule module, and so forth, which may indicate to computing device 708 an in which such rule modules will be placed in decision tree. Building decision tree may include recursively performing mapping of execution results output by one tree and/or subtree to root nodes of another tree and/or subtree, for instance by using such execution results as execution parameters of a subtree. In this manner, computing device 708 may generate connections and/or combinations of one or more trees to one another to define overlaps and/or combinations into larger trees and/or combinations thereof. Such connections and/or combinations may be displayed by visual interface to user, for instance in first view, to enable viewing, editing, selection, and/or deletion by user; connections and/or combinations generated thereby may be highlighted, for instance using a different color, a label, and/or other form of emphasis aiding in identification by a user. In some embodiments, subtrees, previously constructed trees, and/or entire data structures may be represented and/or converted to rule modules, with graphical models representing them, and which may then be used in further iterations or steps of generation of decision tree and/or data structure. Alternatively or additionally subtrees, previously constructed trees, and/or entire data structures may be converted to APIs to interface with further iterations or steps of methods as described in this disclosure. As a further example, such subtrees, previously constructed trees, and/or entire data structures may become remote resources to which further iterations or steps of data structures and/or decision trees may transmit data and from which further iterations or steps of generation of data structure receive data, for instance as part of a decision in a given decision tree node.

Continuing to refer to FIG. 7, decision tree may incorporate one or more manually entered or otherwise provided decision criteria. Decision tree may incorporate one or more decision criteria using an application programmer interface (API). Decision tree may establish a link to a remote decision module, device, system, or the like. Decision tree may perform one or more database lookups and/or look-up table lookups. Decision tree may include at least a decision calculation module, which may be imported via an API, by incorporation of a program module in source code, executable, or other form, and/or linked to a given node by establishing a communication interface with one or more exterior processes, programs, systems, remote devices, or the like; for instance, where a user operating system has a previously existent calculation and/or decision engine configured to make a decision corresponding to a given node, for instance and without limitation using one or more elements of domain knowledge, by receiving an input and producing an output representing a decision, a node may be configured to provide data to the input and receive the output representing the decision, based upon which the node may perform its decision.

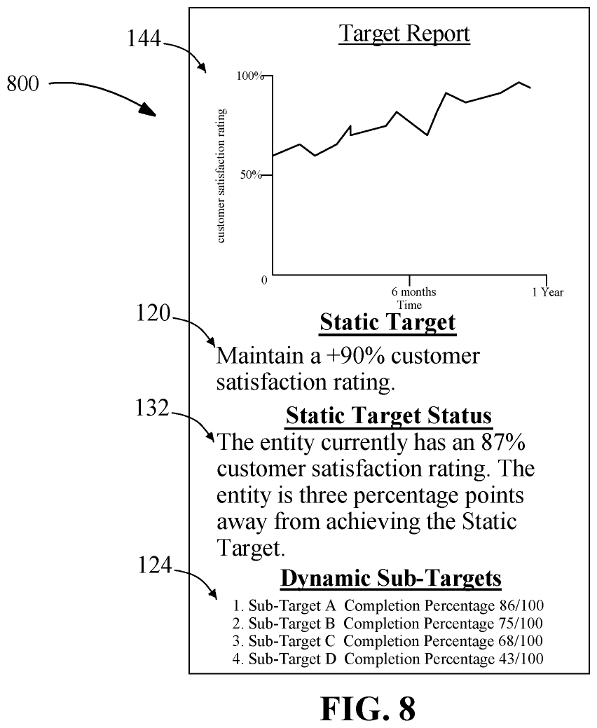

Referring now to FIG. 8, an exemplary embodiment of user interface 800 is illustrated. In some embodiments, display data structure may be configured to cause a display device to display user interface 800. The user interface 800 may include the target report 144, providing a comprehensive overview of entities progress towards its static targets 120. User interface 800 may display a first or a second set of sub-targets along with the current progress of the entity. In some cases, user interface 800 may allow a user to input information into apparatus 100. For example, a user may update the progress of one or more dynamic sub-targets or static targets 120 within user interface 800. In some cases, processor 104 may assign one or more actions of the user interface 800 to an event handler. As used in the current disclosure, an “event handler” is a programming construct or function that responds to and manages events in software applications. An event handler may be a software component or routine that is responsible for detecting, processing, and responding to specific events or actions triggered by the input of data into the apparatus. These event handlers may play a critical role in managing real-time interactions and ensuring that the data within apparatus 100 is processed appropriately. The use of an event handler may be triggered by an event. As used in the current disclosure, an “event” is an occurrence or trigger within a software program, often generated by user actions or system processes. An event is a specific occurrence or action within an application that requires a response. Examples of events include button clicks (i.e. right click, left click, scrolls using the wheel, keys on a keyboard, and the like.), keyboard input, mouse movements, form submissions, timer expirations, hovering over an icon, and the like. In an embodiment, an event hander may be triggered by the click of a button. In an embodiment, an event may include accomplishing a mile stone or completing one or more dynamic sub-targets. These handlers may respond to user clicks on buttons or other interactive elements in a user interface. They can trigger actions like submitting a form, opening a dialog, or navigating to another page. In a non-limiting example, an event of accomplishing one or more dynamic sub-targets may trigger an even handler to generate an additional set of dynamic sub-targets. This may include the generation of the first or second set of dynamic sub-targets.

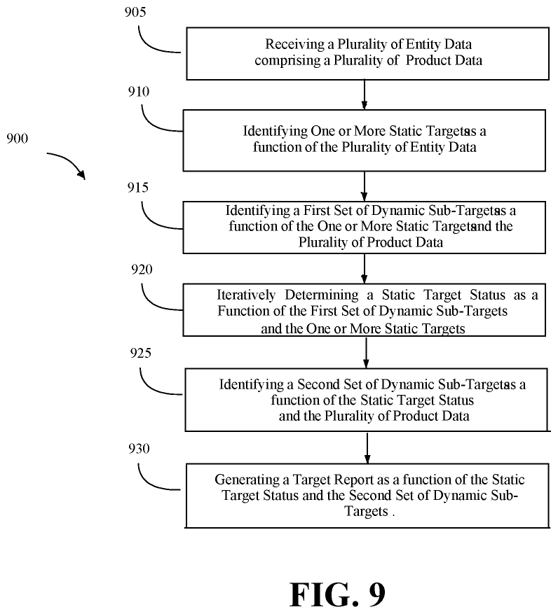

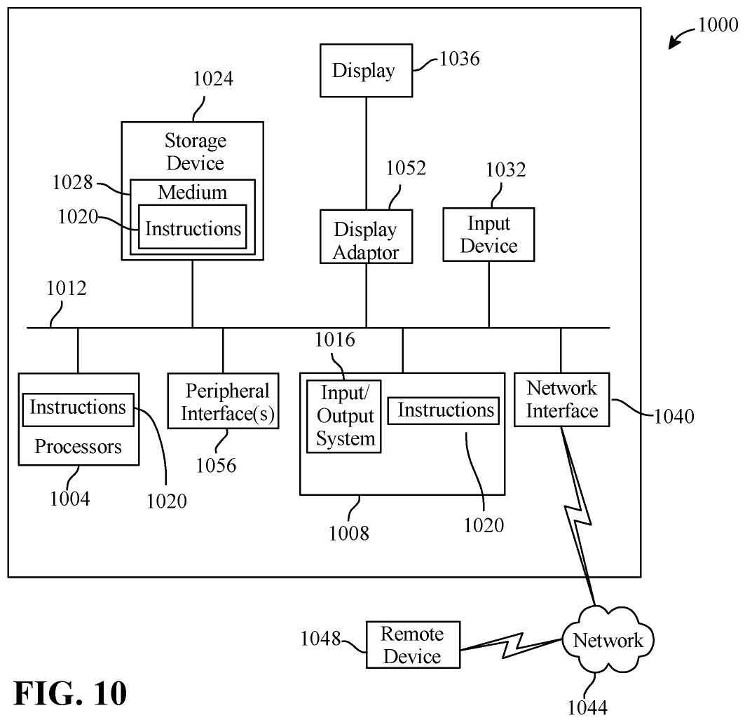

Referring now to FIG. 9, a flow diagram of an exemplary method 900 for the identification of dynamic sub-targets is illustrated. At step 905, method 900 includes receiving, using at least a processor, a plurality of entity data comprising a plurality of product data associated with an entity. This may be implemented as described and with reference to FIGS. 1-8. In some cases, receiving the plurality of entity data may include generating a plurality of entity data using a plurality of tracking cookies or a chatbot.

Still referring to FIG. 9, at step 910, method 900 includes identifying, using the at least a processor, one or more static targets as a function of the plurality of entity data. This may be implemented as described and with reference to FIGS. 1-8. In an embodiment, the one or more static targets may include at least one pecuniary target. In some cases, identifying the one or more static targets may include comparing the plurality of entity data associated with the entity to a plurality of entity data associated with a second entity. This may include an identification the one or more static targets as a function of the comparison.

Still referring to FIG. 9, at step 915, method 900 includes identifying, using the at least a processor, a first set of dynamic sub-targets as a function of the one or more static targets and the plurality of product data. This may be implemented as described and with reference to FIGS. 1-8. Still referring to FIG. 9, at step 920, method 900 includes iteratively determining, using

the at least a processor, a static target status as a function of the first set of dynamic sub-targets and the one or more static targets. This may be implemented as described and with reference to FIGS. 1-8. In an embodiment, identifying the first set of dynamic sub-targets may include iteratively training a sub-target machine learning model using sub-target training data, wherein the sub-target training data comprises the one or more static targets and the plurality of product data as inputs correlated to examples of the first set of dynamic sub-targets. Identifying the first set of dynamic sub-targets may also include identifying the first set of dynamic sub-targets as a function of the one or more static targets and the plurality of product data using a trained sub-target machine learning model.

Still referring to FIG. 9, at step 925, method 900 includes identifying, using the at least a processor, a second set of dynamic sub-targets as a function of the static target status and the plurality of product data. This may be implemented as described and with reference to FIGS. 1-8. In some cases, iteratively determining the static target status may include updating static target status as a function of the second set of dynamic sub-targets. In other cases, iteratively determining the static target status may include updating the static target status in real time.

Still referring to FIG. 9, at step 930, method 900 includes generating, using the at least a processor, a target report as a function of the static target status and the second set of dynamic sub-targets. This may be implemented as described and with reference to FIGS. 1-8.

Still referring to FIG. 9, the method may further include identifying, using the at least a processor, a target group as a function of the entity data. In an embodiment, the method may further include iteratively generating, using the at least a processor, updated product data as a function of the first set of dynamic sub-targets and the static target status. This may include identifying, using the at least a processor, the second set of dynamic sub-targets as a function of the updated product data.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 10 shows a diagrammatic representation of one embodiment of a computing device in the exemplary form of a computer system 1000 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 1000 includes a processor 1004 and a memory 1008 that communicate with each other, and with other components, via a bus 1012. Bus 1012 may include any of several types of bus structures including, but not limited to, a memory bus, a memory controller, a peripheral bus, a local bus, and any combinations thereof, using any of a variety of bus architectures.

Processor 1004 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 1004 may be organized according to Von Neumann and/or Harvard architecture as a non-limiting example. Processor 1004 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 1008 may include various components (e.g., machine-readable media) including, but not limited to, a random-access memory component, a read only component, and any combinations thereof. In one example, a basic input/output system 1016 (BIOS), including basic routines that help to transfer information between elements within computer system 1000, such as during start-up, may be stored in memory 1008. Memory 1008 may also include (e.g., stored on one or more machine-readable media) instructions (e.g., software) 1020 embodying any one or more of the aspects and/or methodologies of the present disclosure. In another example, memory 1008 may further include any number of program modules including, but not limited to, an operating system, one or more application programs, other program modules, program data, and any combinations thereof.

Computer system 1000 may also include a storage device 1024. Examples of a storage device (e.g., storage device 1024) include, but are not limited to, a hard disk drive, a magnetic disk drive, an optical disc drive in combination with an optical medium, a solid-state memory device, and any combinations thereof. Storage device 1024 may be connected to bus 1012 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 1024 (or one or more components thereof) may be removably interfaced with computer system 1000 (e.g., via an external port connector (not shown)). Particularly, storage device 1024 and an associated machine-readable medium 1028 may provide nonvolatile and/or volatile storage of machine-readable instructions, data structures, program modules, and/or other data for computer system 1000. In one example, software 1020 may reside, completely or partially, within machine-readable medium 1028. In another example, software 1020 may reside, completely or partially, within processor 1004.

Computer system 1000 may also include an input device 1032. In one example, a user of computer system 1000 may enter commands and/or other information into computer system 1000 via input device 1032. Examples of an input device 1032 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 1032 may be interfaced to bus 1012 via any of a variety of interfaces (not shown) including, but not limited to, a serial interface, a parallel interface, a game port, a USB interface, a FIREWIRE interface, a direct interface to bus 1012, and any combinations thereof. Input device 1032 may include a touch screen interface that may be a part of or separate from display 1036, discussed further below. Input device 1032 may be utilized as a user selection device for selecting one or more graphical representations in a graphical interface as described above.

A user may also input commands and/or other information to computer system 1000 via storage device 1024 (e.g., a removable disk drive, a flash drive, etc.) and/or network interface device 1040. A network interface device, such as network interface device 1040, may be utilized for connecting computer system 1000 to one or more of a variety of networks, such as network 1044, and one or more remote devices 1048 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 1044, may employ a wired and/or a wireless mode of communication. In general, any network topology may be used. Information (e.g., data, software 1020, etc.) may be communicated to and/or from computer system 1000 via network interface device 1040.

Computer system 1000 may further include a video display adapter 1052 for communicating a displayable image to a display device, such as display device 1036. Examples of a display device include, but are not limited to, a liquid crystal display (LCD), a cathode ray tube (CRT), a plasma display, a light emitting diode (LED) display, and any combinations thereof. Display adapter 1052 and display device 1036 may be utilized in combination with processor 1004 to provide graphical representations of aspects of the present disclosure. In addition to a display device, computer system 1000 may include one or more other peripheral output devices including, but not limited to, an audio speaker, a printer, and any combinations thereof. Such peripheral output devices may be connected to bus 1012 via a peripheral interface 1056. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions, and additions may be made to that which is specifically disclosed herein without departing from the spirit and scope of the present invention.

1. An apparatus for an identification of dynamic sub-targets, wherein the apparatus comprises:
an application-specific integrated circuit instantiating a plurality of neural network nodes, wherein:
the application-specific integrated circuit includes a rewritable read-only memory (ROM) storing a plurality of parameters, wherein the plurality of parameters includes the at least a parameter of each node of the plurality of nodes;
the application-specific integrated circuit includes circuitry for each node of the plurality of nodes, the circuitry configured to perform a mathematical operation on inputs to the node using at least a parameter of the plurality of parameters stored in the ROM; and
at least a processor communicatively connected to the application-specific integrated circuit; and
a memory communicatively connected to the at least a processor, the memory containing instructions configuring the at least a processor to:
receive a plurality of entity data comprising a plurality of product data associated with an entity;
identify one or more static targets as a function of the plurality of entity data using a first objective function, wherein identifying the one or more static targets comprises:
receiving a target area from a user;
selecting a target metric as a function of the target area;
generating the first objective function as a function the target metric; and
selecting the one or more static targets as a function of optimizing the first objective function;
identify a first set of dynamic sub-targets as a function of the one or more static targets and the plurality of product data, wherein identifying the first set of dynamic sub-targets comprises:
configuring the parameters of the rewritable ROM to instantiate a sub-target machine learning model comprising a neural network;
training the sub-target machine learning model as a function of sub-target training data comprising a plurality of examples of entity data inputs and static target inputs correlated to dynamic sub-target outputs, wherein training further comprises updating the plurality of parameters in the rewritable ROM;
receiving user inputs comprising user feedback indicating a quality of previous dynamic sub-target outputs generated based on previous entity data inputs and static target inputs using a user interface;
updating the sub-target training data as a function of the user feedback, wherein updating the sub-target training data as a function of user feedback comprises:
identifying the quality of the dynamic sub-target output as a function of the user feedback, wherein identifying the quality of the dynamic sub-target output comprises generating an accuracy score of the dynamic sub-target output, wherein the accuracy score indicates a degree of retraining required for the sub-target machine learning model;
removing a low quality dynamic sub-target output from the training data, wherein the low quality dynamic sub-target output indicates a low accuracy score;
replacing the low quality dynamic sub-target output with a new dynamic sub-target output;
retraining the sub-target machine learning model using the static target inputs correlated to the new dynamic sub-target output as a function of the degree of retraining indicated by the accuracy score; and
retraining the sub-target machine learning model a function of modified correlations of examples of entity data inputs and static target inputs and dynamic sub-target outputs by updating the parameters in the rewritable ROM,
wherein the processor integrates a feedback loop mechanism to allow the user to provide input on analysis, interpretation, and recommendations;
identify at least one target path as a function of the first set of dynamic sub-targets;
iteratively determine a static target status as a function of the first set of dynamic sub-targets and the one or more static targets using a status machine learning model comprising:
receiving static training data, wherein the static training data correlates a plurality of the first set of dynamic sub-target data and static target data to a plurality of examples of static target data;
training, iteratively, the status machine learning model using the static training data, wherein training the status machine learning model includes retraining the status machine learning model with feedback from previous iterations of the status machine learning model; and
generating the static target status using the trained status machine learning model;
identify a second set of dynamic sub-targets as a function of the static target status and the plurality of product data; and
generate a target report as a function of the static target status and the second set of dynamic sub-targets, wherein the apparatus is further configured to communicate a displayable image to a display device to provide a graphical representation to the user,
wherein the processor is configured to iteratively determine the static target status as a function of the first set of dynamic sub-targets and the one or more static targets, wherein the static target status is data associated with a reflection of the overall progress and performance of an entity in achieving its long-term objectives,
wherein the processor is configured to continuously update the static target status,
wherein the static target status is updated in real time.

2. The apparatus of claim 1, wherein identifying the first set of dynamic sub-targets comprises:
generating a second objective function as a function of an exemplary set of dynamic sub-targets and the one or more static targets;
optimizing the second objective function; and
identifying the first set of dynamic sub-targets as a function of an optimized second objective function.

3. (canceled)

4. The apparatus of claim 1, wherein the memory further instructs the at least a processor to identify a target group as a function of the entity data.

5. The apparatus of claim 1, wherein the memory further instructs the at least a processor to:
iteratively generate updated product data as a function of the first set of dynamic sub-targets and the static target status; and
identify the second set of dynamic sub-targets as a function of the updated product data.

6. The apparatus of claim 1, wherein receiving the plurality of entity data comprises generating a plurality of entity data using a plurality of tracking cookies.

7. The apparatus of claim 1, wherein receiving the plurality of entity data comprises generating a plurality of entity data using a chatbot.

8. The apparatus of claim 1, wherein identifying the one or more static targets comprises:
comparing the plurality of entity data associated with the entity to a plurality of entity data associated with a second entity; and
identifying the one or more static targets as a function of the comparison.

9. The apparatus of claim 1, wherein iteratively determining the static target status comprises updating static target status as a function of the second set of dynamic sub-targets.

10. The apparatus of claim 1, wherein the static target status comprises one or more vital metrics associated with the one or more static targets.

11. A method for an identification of dynamic sub-targets, wherein the method comprises:
providing an apparatus including a processor and an application-specific integrated circuit communicatively connected to the processor, the application-specific integrated circuit instantiating a plurality of neural network nodes, wherein:
the application-specific integrated circuit includes a rewritable read-only memory (ROM) storing a plurality of parameters, wherein the plurality of parameters includes the at least a parameter of each node of the plurality of nodes;
the application-specific integrated circuit includes circuitry for each node of the plurality of nodes, the circuitry configured to perform a mathematical operation on inputs to the node using at least a parameter retrieved from memory; and
receiving, using the at least a processor, a plurality of entity data comprising a plurality of product data associated with an entity, wherein the processor integrates a feedback loop mechanism to allow [the] a user to provide input on analysis, interpretation, and recommendations;
identifying, using the at least a processor, one or more static targets as a function of the plurality of entity data using a first objective function, wherein identifying the one or more static targets comprises:
receiving a target area from a user;
selecting a target metric as a function of the target area;
generating a first objective function as a function the target metric; and
selecting the one or more static targets as a function of optimizing the first objective function;
identifying, using the at least a processor, a first set of dynamic sub-targets as a function of the one or more static targets and the plurality of product data, wherein identifying the first set of dynamic sub-targets comprises:
configuring the parameters of the rewritable ROM to instantiate a sub-target machine learning model comprising a neural network;
training the sub-target machine learning model as a function of sub-target training data comprising a plurality of examples of entity data inputs and static target inputs correlated to dynamic sub-target outputs, wherein training further comprises updating the plurality of parameters in the rewritable ROM;
receiving user inputs comprising user feedback indicating an quality of previous dynamic sub-target outputs generated based on previous entity data inputs and static target inputs using a user interface;
updating the sub-target training data as a function of the user feedback, wherein updating the sub-target training data as a function of user feedback comprises:
identifying the quality of the dynamic sub-target output as a function of the user feedback, wherein identifying the quality of the dynamic sub-target output comprises:
generating an accuracy score of the dynamic sub-target output;
removing a low quality dynamic sub-target output from the training data, wherein the low quality dynamic sub-target output indicates a low accuracy score;
replacing the low quality dynamic sub-target output with a new dynamic sub-target output;
retraining the sub-target machine learning model using the static target inputs correlated to the new dynamic sub-target output; and
retraining the sub-target machine learning model a function of modified correlations of examples of entity data inputs and static target inputs and dynamic sub-target outputs by updating the parameters in the rewritable ROM;
identifying, using the at least a processor, at least one target path as a function of the first set of dynamic sub-targets;
iteratively determining, using the at least a processor, a static target status comprising data associated with progress of the user in achieving a long-term objective as a function of the first set of dynamic sub-targets and the one or more static targets using a status machine learning model comprising:
receiving static training data, wherein the static training data correlates a plurality of the first set of dynamic sub-target data and static target data to a plurality of examples of static target data;
training, iteratively, the status machine learning model using the static training data, wherein training the status machine learning model includes retraining the status machine learning model with feedback from previous iterations of the status machine learning model; and
generating the static target status using the trained status machine learning model;
identifying, using the at least a processor, a second set of dynamic sub-targets as a function of the static target status and the plurality of product data;
generating, using the at least a processor, a target report as a function of the static target status and the second set of dynamic sub-targets, wherein the target report comprises predictions related to an entity's future cash flow and includes tracking of the entity's current cash flow;
recommending, using the at least a processor, cash flow optimization strategies to the user; and
communicating a displayable image to a display device to provide a graphical representation to the user,
wherein the processor is configured to iteratively determine the static target status as a function of the first set of dynamic sub-targets and the one or more static targets, wherein the static target status is data associated with a reflection of the overall progress and performance of an entity in achieving its long-term objectives,
wherein the processor is configured to continuously update the static target status,
wherein the static target status is updated in real time.

12. The method of claim 11, wherein identifying the first set of dynamic sub-targets comprises:
generating a second objective function as a function of an exemplary set of dynamic sub-targets and the one or more static targets;
optimizing the second objective function; and
identifying the first set of dynamic sub-targets as a function of an optimized second objective function.

13. (canceled)

14. The method of claim 11, wherein the method further comprises identifying, using the at least a processor, a target group as a function of the entity data.

15. The method of claim 11, wherein the method further comprises:
iteratively generating, using the at least a processor, updated product data as a function of the first set of dynamic sub-targets and the static target status; and
identifying, using the at least a processor, the second set of dynamic sub-targets as a function of the updated product data.

16. The method of claim 11, wherein receiving the plurality of entity data comprises generating a plurality of entity data using a plurality of tracking cookies.

17. The method of claim 11, wherein receiving the plurality of entity data comprises generating a plurality of entity data using a chatbot.

18. The method of claim 11, wherein identifying the one or more static targets comprises:
comparing the plurality of entity data associated with the entity to a plurality of entity data associated with a second entity; and
identifying the one or more static targets as a function of the comparison.

19. The method of claim 11, wherein iteratively determining the static target status comprises updating static target status as a function of the second set of dynamic sub-targets.

20. The method of claim 11, wherein the static target status comprises one or more vital metrics associated with the one or more static targets.
